(19) United States
(12) Patent Application Publication
(10) Pub. No.: US 2020/0282360 A1
(43) Pub. Date: Sep. 10, 2020

(54) NANOCARBON SEPARATION DEVICE AND NANOCARBON SEPARATION METHOD

(71) Applicant: NEC CORPORATION, Tokyo (JP)

(72) Inventor: Kazuki IHARA, Tokyo (JP)

(73) Assignee: NEC CORPORATION, Tokyo (JP)

(21) Appl. No.: 16/753,881

(22) PCT Filed: Oct. 3, 2018
(86) PCT No.: PCT/JP2018/037016

§ 371 Date: Apr. 6, 2020

(30) Foreign Application Priority Data
Oct. 10, 2017 (JP) 2017-197276

(51) Int. Cl. B01D 57/02; C01B 32/172

(52) U.S. Cl. CPC B01D 57/02; B82Y 40/00; C01B 32/172

(57) ABSTRACT

A nanocarbon separation device includes a porous structure configured to hold a dispersion liquid containing nanocarbons, a first electrode disposed to come into contact with at least a part of an upper end of the porous structure, and a second electrode disposed to come into contact with at least a part of a lower end of the porous structure.

### TECHNICAL FIELD

The present invention relates to a nanocarbon separation device and a nanocarbon separation method.

### BACKGROUND ART

In recent years, carbon materials having sizes on a nanometer scale (hereinafter, referred to as “nanocarbons”) have come to be expected to be applied to various fields due to the mechanical properties, electrical properties, and chemical properties thereof.

Regarding nanocarbons, nanocarbons having different properties may be simultaneously generated in a manufacturing operation. In a state in which nanocarbons having different electrical properties are mixed, when the nanocarbons are used as an electronic material, problems such as deterioration of properties or the like may occur. Here, the nanocarbons having different properties need to be separated.

Patent Literature 1 discloses a nanocarbon material separating method including an introduction and disposing process, and a separation process in order to separate nanocarbons. The introduction and disposing process is a process of laminating a dispersion solution of a nanocarbon material and a holding solution having a specific gravity different from the nanocarbon material distributed into nanocarbon micelle groups having a plurality of different charges in a predetermined direction in an electrophoretic tank, by introducing and disposing the solutions. The separation process is a process of separating the nanocarbon micelle groups into two or more nanocarbon micelle groups by applying a voltage to the dispersion solution and the holding solution that are laminated, by being introduced and disposed, in a serial direction.

### CITATION LIST

### Patent Literature

### Patent Literature 1

PCT International Publication No. WO 2010/150808 A1

### SUMMARY OF INVENTION

### Problem to be Solved by the Invention

However, in a separation method disclosed in Patent Literature 1, in introduction/collection of the separating solution at the beginning or end of the separation, it is necessary to take liquids in and out accurately without disturbance. For this reason, there is a problem in that the time required for the introduction/collection of the separating solution becomes longer.

The present invention is directed to providing a nanocarbon separation device and a nanocarbon separation method that minimize an influence due to a disturbance or the like during introduction/collection of a separating solution into/from an electrophoretic tank and efficiently perform the introduction/collection in separation of nanocarbons having different properties.

### Means for Solving the Problem

A nanocarbon separation device of the present invention includes a porous structure configured to hold a dispersion liquid containing nanocarbons; a first electrode disposed to come into contact with at least a part of an upper end of the porous structure; a second electrode disposed to come into contact with at least a part of a lower end of the porous structure; and a direct current power supply configured to apply a direct current voltage between the first electrode and the second electrode.

A nanocarbon separation method of the present invention includes a process of holding a dispersion liquid containing nanocarbons in a porous structure; a process of causing a first electrode to come into contact with at least a part of an upper end of the porous structure and causing a second electrode to come into contact with at least a part of a lower end of the porous structure; and a process of applying a direct current voltage between the first electrode and the second electrode, moving metal type nanocarbons contained in the dispersion liquid toward the first electrode and moving semiconductor type nanocarbons contained in the dispersion liquid toward the second electrode, and separating the metal type nanocarbons and the semiconductor type nanocarbons.

### Advantageous Effects of Invention

According to the present invention, it is possible to minimize an influence due to a disturbance or the like during introduction/collection of a separating solution into an electrophoretic tank and efficiently perform the introduction/collection in separation of nanocarbons having different properties.

### BRIEF DESCRIPTION OF DRAWINGS

FIG. 1 is a schematic diagram showing a nanocarbon separation device of a first embodiment.

FIG. 2 is a schematic diagram showing a nanocarbon separation method of the first embodiment.

FIG. 3 is a schematic diagram showing the nanocarbon separation method of the first embodiment.

FIG. 4 is a schematic diagram showing the nanocarbon separation method of the first embodiment.

FIG. 5 is a schematic diagram showing the nanocarbon separation method of the first embodiment.

FIG. 6 is a schematic diagram showing the nanocarbon separation method of the first embodiment.

FIG. 7 is a flowchart showing the nanocarbon separation method of the embodiment.

FIG. 8 is a schematic diagram showing a nanocarbon separation device of a second embodiment.

FIG. 9 is a schematic diagram showing a nanocarbon separation method of the second embodiment.

FIG. 10 is a schematic diagram showing the nanocarbon separation method of the second embodiment.

FIG. 11 is a schematic diagram showing the nanocarbon separation method of the second embodiment.

FIG. 12 is a schematic diagram showing the nanocarbon separation method of the second embodiment.

FIG. 13 is a schematic diagram showing the nanocarbon separation method of the second embodiment.

FIG. 14 is a schematic diagram showing a nanocarbon separation device of a third embodiment.

FIG. 15 is a schematic diagram showing a nanocarbon separation method of the third embodiment.

FIG. 16 is a schematic diagram showing the nanocarbon separation method of the third embodiment.

FIG. 17 is a schematic diagram showing the nanocarbon separation method of the third embodiment.

FIG. 18 is a schematic diagram showing the nanocarbon separation method of the third embodiment.

FIG. 19 is a schematic diagram showing a nanocarbon separation device of a fourth embodiment.

FIG. 20 is a schematic diagram showing a nanocarbon separation method of the fourth embodiment.

FIG. 21 is a schematic diagram showing the nanocarbon separation method of the fourth embodiment.

FIG. 22 is a schematic diagram showing the nanocarbon separation method of the fourth embodiment.

FIG. 23 is a schematic diagram showing the nanocarbon separation method of the fourth embodiment.

FIG. 24 is a schematic diagram showing a nanocarbon separation device of a fifth embodiment.

### DESCRIPTION OF EMBODIMENTS

Embodiments of a nanocarbon separation device and a nanocarbon separation method of the present invention will be described.

Further, the embodiments are specifically described for better understanding of the spirit of the invention, and do not limit the present invention unless the context clearly indicates otherwise.

### First Embodiment

### Nanocarbon Separation Device

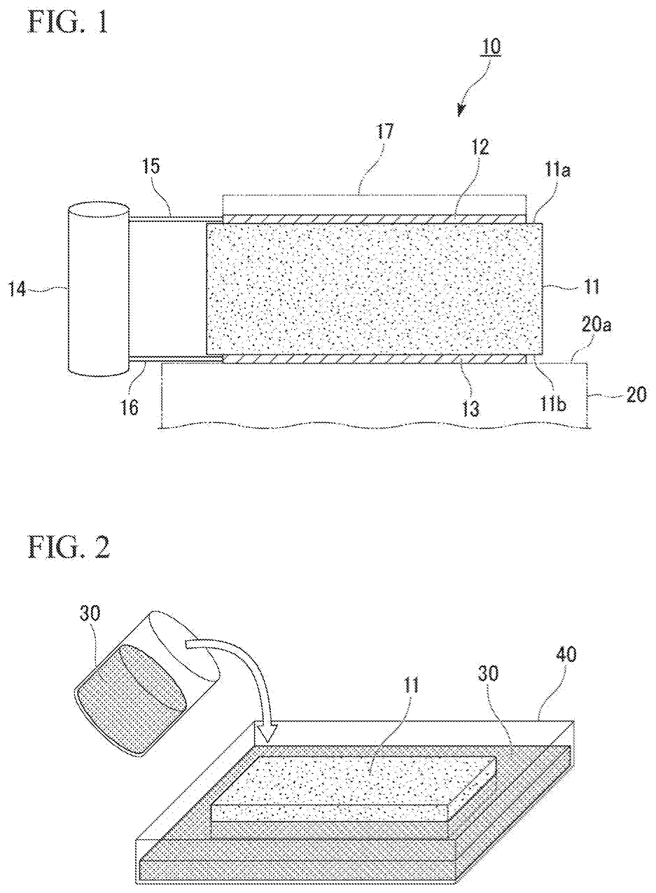

FIG. 1 is a schematic diagram showing a nanocarbon separation device of the embodiment.

A nanocarbon separation device 10 of the embodiment includes a porous structure 11 configured to hold a dispersion liquid containing nanocarbons, a first electrode 12 disposed to come into contact with an upper end (an upper surface) 11a of the porous structure 11, and a second electrode 13 disposed to come into contact with a lower end (a lower surface) 11b of the porous structure 11. In addition, the nanocarbon separation device 10 of the embodiment may include a direct current power supply 14 configured to apply a direct current voltage between the first electrode 12 and the second electrode 13. The direct current power supply 14 is electrically connected to the first electrode 12 via a cable 15 and electrically connected to the second electrode 13 via a cable 16.

For example, as shown in FIG. 1, the porous structure 11 is formed of a sponge that is a porous soft object in which numerous fine holes (hereinafter, referred to as “pores”) are formed.

An external form of the porous structure 11 is not particularly limited as long as the dispersion liquid containing the nanocarbons (hereinafter, referred to as a “nanocarbon dispersion liquid”) can infiltrate thereinto and be held therein. As the external forms of the porous structure 11, for example, a columnar shape, a triangular prismatic shape, a quadrangular prismatic shape, a polygonal prismatic shape of a pentagon or more, or the like, may be exemplified.

The sponge that forms the porous structure 11 is not particularly limited. A material of the sponge is not particularly limited as long as the material is stable with respect to the dispersion liquid containing metal type nanocarbons and semiconductor type nanocarbons (hereinafter, referred to as a “nanocarbon dispersion liquid”) and is an insulating material. The sponge is a porous body in which numerous fine holes are formed. Examples of the sponge include those formed of natural sponge, artificial sponge formed of a synthetic resin, and the like. In addition, instead of a sponge, a gel, a pumice stone, or the like, may be used in the porous structure 11.

In addition, the porous structure 11 may have a plurality of regions layered in a thickness direction. That is, the porous structure 11 may be obtained by laminating a plurality of plate-shaped units having a predetermined thickness. The thickness direction is, for example, an upward/downward direction in FIG. 1. In other words, the thickness direction is, for example, a direction in which the nanocarbons are separated. The plurality of units (regions) may have the same thickness or may have different thicknesses. After metal type nanocarbons and semiconductor type nanocarbons are separated, only regions in which one of respective nanocarbons thereof is contained can be extracted as long as the porous structure 11 has a plurality of regions layered in the thickness direction.

The size (height, outer diameter, volume, or the like) of the porous structure 11 is not particularly limited, and is appropriately adjusted according to the amount of the nanocarbon dispersion liquid held in the porous structure 11.

The porosity degree (porosity) in the porous structure 11 may be any porosity degree as long as nanocarbon micelles can pass therethrough, pores are continuously connected, and a potential gradient is formed between upper and lower electrodes. For example, the porosity degree (porosity) in the porous structure 11 using the synthetic sponge is preferably 80% or more and 99.9% or less, or more preferably 90% or more and 99% or less. As an example, a sponge for absorption formed of a urethane foam having a porosity of 98.5% (for example, TRUSCO absorption sponge manufactured by Trusco Nakayama) may be used.

When the porosity degree in the porous structure 11 is equal to or greater than 80%, the pores communicate with each other in the entire region of the porous structure 11. For this reason, in separation of the nanocarbon dispersion liquid using the nanocarbon separation device 10, the porous structure 11 does not prevent movement of the metal type nanocarbons and the semiconductor type nanocarbons contained in the nanocarbon dispersion liquid. Accordingly, the metal type nanocarbons and the semiconductor type nanocarbons contained in the nanocarbon dispersion liquid can be efficiently separated. Meanwhile, when the porosity degree in the porous structure 11 is equal to or less than 99.9%, the nanocarbon dispersion liquid infiltrating into the porous structure 11 can be stably held in the porous structure 11.

The porosity degree of the porous structure 11 relates to a proportion of the porous structure 11 occupied by pores with respect to the entire volume of the porous structure 11. The porosity degree of the porous structure 11 is represented by, for example, the following formula (1).

a1/A1×100 (1)

That is, the porosity degree of the porous structure 11 is represented as a percentage which is a ratio between a total volume a1 of the pores in the porous structure 11 and a total volume A1 of the porous structure 11 including the pores.

As a method of obtaining the porosity degree of the porous structure 11, for example, a method of obtaining an apparent specific gravity d1 of the porous structure 11 including the pores and a true specific gravity D1 of the porous structure 11 including the pores and calculating a porosity degree of the porous structure 11 on the basis of these specific gravities is exemplified. In this method, the porosity degree of the porous structure 11 is calculated on the basis of the following formula (2).

(D1−d1)/D1×100 (2)

Sizes of the pores in the porous structure 11, i.e., inner diameters of the pores are preferably equal to or greater than 40 nm, and more preferably equal or greater than 100 nm. In addition, the inner diameters of the pores in the porous structure 11 are equal to or less than 1 cm, and more preferably equal to or less than 1 mm.

When the inner diameters of the pores in the porous structure 11 are equal to or greater than 40 nm, in separation of the nanocarbon dispersion liquid using the nanocarbon separation device 10, the porous structure 11 does not prevent movement of the metal type nanocarbons and the semiconductor type nanocarbons contained in the nanocarbon dispersion liquid. Accordingly, the metal type nanocarbons and the semiconductor type nanocarbons contained in the nanocarbon dispersion liquid can be efficiently separated.

Further, shapes of the pores in the porous structure 11 are irregular shapes, for example, spherical shapes, spheroidal shapes, and the like. For this reason, the inner diameters of the pores in the porous structure 11 are diameters of spherical bodies when the pores are formed in spherical shapes, large diameters of spheroidal shapes when the pores are formed in spheroidal shapes, and lengths of the longest portion of the shape when the pores are formed in shapes other than spherical shapes and spheroidal shapes.

As a method of obtaining the sizes of the pores in the porous structure 11, for example, a method of observing the porous structure 11 using an optical microscope or a scanning electron microscope and actually measuring the sizes of the pores on the basis of microscopic images thereof, or the like, may be exemplified.

The porous structure 11 is preferably transparent, milky-white translucent (white with the back showing through), or milky-white (white that is not transparent, translucent), in order to easily allow a separation state of the metal type nanocarbons and the semiconductor type nanocarbons contained in the nanocarbon dispersion liquid to be checked. When separation of the metal type nanocarbons and the semiconductor type nanocarbons is performed, the nanocarbon dispersion liquid is colored according to diameters and chirality of the nanocarbons. Here, the separation state of the metal type nanocarbons and the semiconductor type nanocarbons is preferably visually checked using colors of the porous structure 11 as a background.

In the nanocarbon separation device 10 of the embodiment, the first electrode 12 is a negative electrode, and the second electrode 13 is a positive electrode. In this case, when a direct current voltage is applied to the first electrode 12 and the second electrode 13, an orientation of an electric field is directed from the lower end 11b of the porous structure 11 toward the upper end 11a.

The first electrode 12 and the second electrode 13 are not particularly limited as long as the electrodes can be used in electrophoresis and are stable with respect to the nanocarbon dispersion liquid. As the first electrode 12 and the second electrode 13, for example, a platinum electrode or the like is exemplified.

The first electrode 12 comes into contact with the upper end 11a of the porous structure 11 and is fixed to the upper end 11a of the porous structure 11. The second electrode 13 comes into contact with the lower end 11b of the porous structure 11 and is fixed to the lower end 11b of the porous structure 11.

Structures of the first electrode 12 and the second electrode 13 are not particularly limited and may be appropriately selected according to shape, size, or the like, of the porous structure 11. As the structures of the first electrode 12 and the second electrode 13, for example, when seen in plan view of the porous structure 11, an annular shape, a disk shape, a rod shape, or the like, is exemplified. In addition, as the structures of the first electrode 12 and the second electrode 13, for example, a porous plate shape in which a plurality of fine pores are homogenously provided.

Further, while the case in which the first electrode 12 is provided on substantially the entire surface of the upper end 11a of the porous structure 11 and the second electrode 13 is provided on substantially the entire surface of the lower end 11b of the porous structure 11 has been exemplified in FIG. 1, the nanocarbon separation device 10 of the embodiment is not limited thereto. In the nanocarbon separation device 10 of the embodiment, the first electrode 12 may be provided on at least a part of the upper end 11a of the porous structure 11, and in addition, the second electrode 13 may be provided on at least a part of the lower end 11b of the porous structure 11 as long as a direct current voltage can be sufficiently applied between the first electrode 12 and the second electrode 13.

As shown in FIG. 1, in a state in which the porous structure 11 is disposed on a surface 20a of a substrate 20 such as a flat plate or the like, a weight 17 is preferably disposed on the first electrode 12 provided on the upper end 11a of the porous structure 11. As a result, adhesion between the porous structure 11, the first electrode 12 and the second electrode 13 can be increased.

In addition, in order to increase adhesion between the porous structure 11, the first electrode 12 and the second electrode 13, the following configuration is preferably provided. That is, in a state in which the first electrode 12 is provided to come into contact with the upper end 11a of the porous structure 11 and the second electrode 13 is provided to come into contact with the lower end 11b of the porous structure 11, a means configured to sandwich the first electrode 12 and the second electrode 13 in the thickness direction of the porous structure 11 is preferably provided.

The direct current power supply 14 is not particularly limited as long as a direct current voltage can be applied between the first electrode 12 and the second electrode 13.

In the nanocarbon separation device 10 of the embodiment, while the case in which the first electrode 12 is the negative electrode and the second electrode 13 is the positive electrode has been exemplified, the nanocarbon separation device 10 of the embodiment is not limited thereto. In the nanocarbon separation device 10 of the embodiment, the first electrode 12 may be a positive electrode and the second electrode 13 may be a negative electrode.

According to the nanocarbon separation device 10 of the embodiment, the porous structure 11 configured to hold the nanocarbon dispersion liquid is provided between the first electrode 12 and the second electrode 13. Accordingly, for example, the following nanocarbon separation method can be realized as follows in a process of separating metal type nanocarbons and semiconductor type nanocarbons contained in the nanocarbon dispersion liquid. That is, the separation can be started immediately by introducing the nanocarbon dispersion liquid between the electrodes without disturbance or elaborate work. In addition, even in collection after termination of the separation, the nanocarbons can be rapidly collected without receiving an influence of the mixing due to the disturbance of the dispersion solution.

### Nanocarbon Separation Method

An action of the nanocarbon separation device 10 will be described while describing a nanocarbon separation method using the nanocarbon separation device 10 with reference to FIGS. 1 to 7.

The nanocarbon separation method of the embodiment has a holding process, a contact process and a separation process. In the holding process, a nanocarbon dispersion liquid is held in the porous structure 11. In the contact process, the first electrode 12 comes into contact with at least a part of the upper end 11a of the porous structure 11, and the second electrode 13 comes into contact with at least a part of the lower end 11b of the porous structure 11. In the separation process, a direct current voltage is applied between the first electrode 12 and the second electrode 13, the semiconductor type nanocarbons contained in the nanocarbon dispersion liquid is moved toward the second electrode 13 while the metal type nanocarbons contained in the nanocarbon dispersion liquid is moved toward the first electrode 12, and thus, the metal type nanocarbons and the semiconductor type nanocarbons are separated.

In addition, the nanocarbon separation method of the embodiment may have a process of collecting the metal type nanocarbons and the semiconductor type nanocarbons contained in the nanocarbon dispersion liquid after the separation process (hereinafter, referred to as a “collecting process”).

In the nanocarbon separation method of the embodiment, for example, nanocarbon means a carbon material that is mainly constituted by carbon, such as a single-walled carbon nanotube, a double-walled carbon nanotube, a multi-walled carbon nanotube, a carbon nanohorn, a carbon nanotwist, graphene, fullerene, or the like. In the nanocarbon separation method of the embodiment, a case in which the semiconductor type single-walled carbon nanotubes and the metal type single-walled carbon nanotubes are separated from the nanocarbon dispersion liquid containing the single-walled carbon nanotubes as the nanocarbons will be described in detail.

Single-walled carbon nanotubes are known to be able to be classified according to two different properties thereof such as a metal type and a semiconductor type according to a diameter of a tube and a winding method. When the single-walled carbon nanotubes are synthesized using a conventional manufacturing method, a mixture of the single-walled carbon nanotubes in which the metal type single-walled carbon nanotubes having metallic properties and the semiconductor type single-walled carbon nanotube having semiconductive properties are contained at a ratio of 1:2 statistically is obtained.

The mixture of the single-walled carbon nanotubes is not particularly limited as long as the metal type single-walled carbon nanotubes and the semiconductor type single-walled carbon nanotubes are contained. In addition, the single-walled carbon nanotubes in the embodiment may be a single substance single-walled carbon nanotubes, or may be a single-walled carbon nanotube in which some carbon is replaced with an arbitrary functional group or a single-walled carbon nanotube modified by an arbitrary functional group.

First, a single-walled carbon nanotube dispersion liquid (the nanocarbon dispersion liquid 30 shown in FIG. 2) in which the mixture of the single-walled carbon nanotubes is distributed in the dispersion medium together with the surfactant is prepared.

The dispersion medium is not particularly limited as long as the mixture of the single-walled carbon nanotube can be distributed. As the dispersion medium, for example, water (light water), heavy water, organic solvents, ionic liquids, and the like, may be exemplified. Among these dispersion mediums, water or heavy water is preferably used due to the reason that the single-walled carbon nanotubes do not degenerate therein.

As the surfactant, for example, a nonionic surfactant, a cationic surfactant, an anionic surfactant, or the like, is used. In order to prevent ionic impurities such as sodium ions or the like from being mixed with the single-walled carbon nanotubes, a nonionic surfactant is preferably used.

As the nonionic surfactant, a nonionic surfactant having a non-ionizable hydrophilic area and a hydrophobic area such as an alkyl chain is used. As such a nonionic surfactant, for example, a nonionic surfactant having a polyethylene glycol structure represented by polyoxyethylene alkyl ethers is exemplified.

As such a nonionic surfactant, polyoxyethylene alkyl ether expressed by the following formula (3) is appropriately used.

CnH2n(OCH2CH2)mOH (3)

(provided, n=12 to 18 and m=20 to 100)

As the polyoxyethylene alkyl ether expressed by the formula (3), for example, polyoxyethylene (23) lauryl ether (Trade Name: Brij L23, manufactured by Sigma Aldrich Corporation), polyoxyethylene (20) cetyl ether (Trade Name: Brij C20, manufactured by Sigma Aldrich Corporation), polyoxyethylene (20) stearyl ether (Trade Name: Brij S20, manufactured by Sigma Aldrich Corporation), polyoxyethylene (20) oleyl ether (Trade Name: Brij O20, manufactured by Sigma Aldrich Corporation), polyoxyethylene (100) stearyl ether (Trade Name: Brij S100, manufactured by Sigma Aldrich Corporation), or the like, is exemplified.

As the nonionic surfactant, polyoxyethylene sorbitan monostearate (molecular formula: C64H126O26, Trade Name: Tween 60, manufactured by Sigma Aldrich Corporation), polyoxyethylene sorbitan trioleate (molecular formula: C24H44O6, Trade Name: Tween 85, manufactured by Sigma Aldrich Corporation), octylphenol ethoxylate (molecular formula: C14H22O(C2H4O)n, n=1 to 10, Trade Name: Triton X-100, manufactured by Sigma Aldrich Corporation), polyoxyethylene (40) isooctyl phenyl ether (molecular formula: C8H17C6H40(CH2CH2O)40H, Trade Name: Triton X-405, manufactured by Sigma Aldrich Corporation), poloxamer (molecular formula: C5H10O2, Trade Name: Pluronic, manufactured by Sigma Aldrich Corporation), polyvinyl pyrrolidone (molecular formula: (C6H9NO) n, n=5 to 100, manufactured by Sigma Aldrich Corporation) may also be exemplified.

A content of the nonionic surfactant in the single-walled carbon nanotube dispersion liquid is preferably 0.1 wt % or more and 5 wt % or less, and more preferably, 0.5 wt % or more and 2 wt % or less.

When the content of the nonionic surfactant is 0.1 wt % or more, a pH gradient of the single-walled carbon nanotube dispersion liquid can be formed in a separation tank 20 through electrophoresis.

Meanwhile, when the content of the nonionic surfactant is 5 wt % or less, the viscosity of the single-walled carbon nanotube dispersion liquid does not become too high. For this reason, the metal type single-walled carbon nanotubes and the semiconductor type single-walled carbon nanotubes contained in the single-walled carbon nanotube dispersion liquid can be easily separated through electrophoresis.

The content of the single-walled carbon nanotubes in the single-walled carbon nanotube dispersion liquid is preferably 1 μg/mL or more and 100 μg/mL or less, and preferably, 5 μg/mL or more and 40 μg/mL or less.

When the content of the single-walled carbon nanotubes is in the above-mentioned ranges, the metal type single-walled carbon nanotubes and the semiconductor type single-walled carbon nanotubes contained in the single-walled carbon nanotube dispersion liquid can be easily separated through electrophoresis.

The method of preparing the single-walled carbon nanotube dispersion liquid is not particularly limited, and a known method is used as the method. For example, a method of ultrasonicating the liquid mixture of the mixture of the single-walled carbon nanotubes and the dispersion medium containing the surfactant, and dispersing the mixture of the single-walled carbon nanotubes in the dispersion medium may be exemplified. The metal type single-walled carbon nanotubes and the semiconductor type single-walled carbon nanotubes, which are aggregated, are sufficiently separated through the ultrasonication. Accordingly, the single-walled carbon nanotube dispersion liquid is obtained by uniformly dispersing the metal type single-walled carbon nanotubes and the semiconductor type single-walled carbon nanotubes in the dispersion medium. Accordingly, the metal type single-walled carbon nanotubes and the semiconductor type single-walled carbon nanotubes are easily separated through the electrophoresis, which will be described below. Further, the metal type single-walled carbon nanotubes and the semiconductor type single-walled carbon nanotubes that are not dispersed through the ultrasonication are preferably separated and removed through ultracentrifugation.

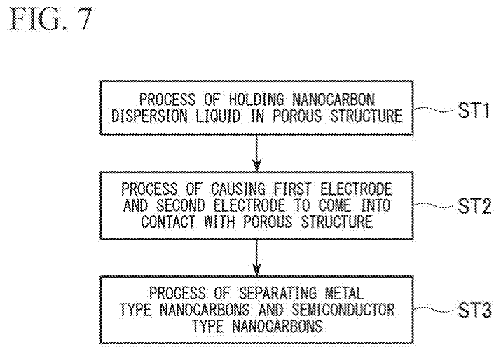

Next, a process of holding the single-walled carbon nanotube dispersion liquid in the porous structure 11 is performed in the holding process (ST1 in FIG. 7).

In the holding process, as shown in FIG. 2, the porous structure 11 is disposed in a dispersion liquid tank 40. Next, the single-walled carbon nanotube dispersion liquid is injected into the dispersion liquid tank 40, the single-walled carbon nanotube dispersion liquid infiltrates into the porous structure 11 in the dispersion liquid tank 40, and the single-walled carbon nanotube dispersion liquid is held in the porous structure 11.

The porous structure 11 that holds the single-walled carbon nanotube dispersion liquid through the holding process may be used as it is as long as the held dispersion liquid is not lost, or a structure configured to prevent evaporation of a liquid to surroundings of the porous structure (the coating material) may be attached thereto. As an example of the coating material that prevents evaporation of the liquid, any material can also be used as long as a solvent does not pass therethrough. As the coating material, for example, a polymeric film such as a polyvinylchloride film, a polyvinylidene chloride film, a polypropylene film, a polyacrylonitrile film, a nylon film, a polyethylene terephthalate film, a polyethylene naphthalate film, or the like, a paper such as an oil paper, a parafilm, or the like, a rubber film, a rubber tube, a housing or a glass tube formed of a glass film, a thin plastic housing, or the like, may be used. In addition, the electrodes can easily contact the upper section and the lower section in the contact process, which will be described below, using a structure in which the coating materials of the upper section, the lower section and the peripheral section of the porous structure 11 are split.

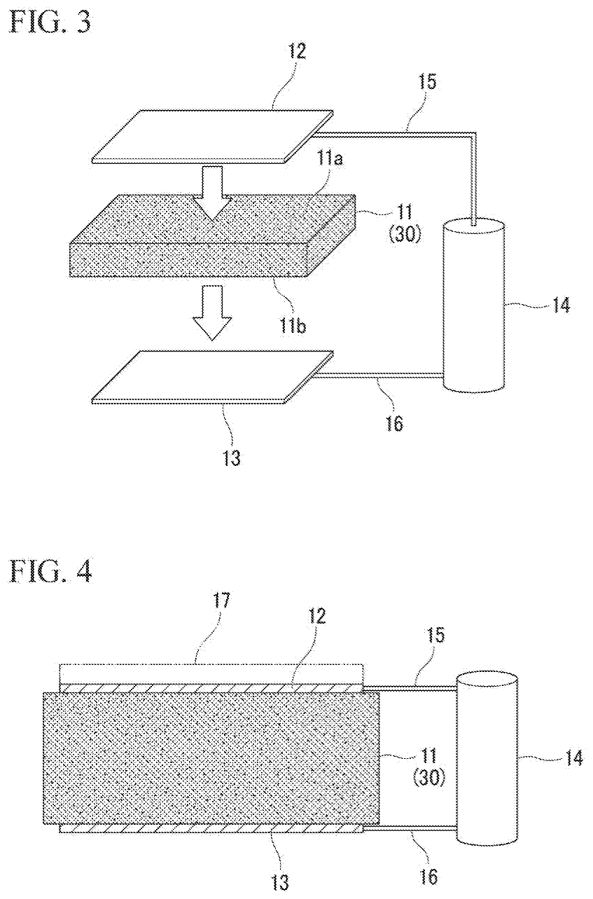

Next, in the contact process, as shown in FIG. 3, a process of causing the first electrode 12 to come into contact with at least a part of the upper end 11a of the porous structure 11, and causing the second electrode 13 to come into contact with at least a part of the lower end 11b of the porous structure 11 is performed (ST2 in FIG. 7).

Here, in advance, the direct current power supply 14 is electrically connected to the first electrode 12 via the cable 15, and electrically connected to the second electrode 13 via the cable 16.

In addition, in order to increase adhesion between the porous structure 11, the first electrode 12 and the second electrode 13, the weight 17 is preferably disposed on the first electrode 12 provided on the upper end 11a of the porous structure 11.

Next, in the separation process, as shown in FIG. 4, a process of moving the metal type single-walled carbon nanotube contained in the single-walled carbon nanotube dispersion liquid toward the first electrode 12 and moving the semiconductor type single-walled carbon nanotubes contained in the single-walled carbon nanotube dispersion liquid toward the second electrode 13 is performed through electrophoresis. Accordingly, the metal type single-walled carbon nanotubes and the semiconductor type single-walled carbon nanotubes are separated (ST3 in FIG. 7).

An electric field is formed in the porous structure 11 by applying a direct current voltage to the first electrode 12 and the second electrode 13 for a predetermined time (for example, 1 hour to 24 hours). Specifically, the electric field is formed such that an orientation of the electric field is directed from a downward side toward an upward side of the porous structure 11. The mixture of the single-walled carbon nanotubes contained in the single-walled carbon nanotube dispersion liquid is separated into the metal type single-walled carbon nanotubes and the semiconductor type single-walled carbon nanotubes by an electrophoretic force generated due to the electric field and charges of the single-walled carbon nanotubes.

In the single-walled carbon nanotube dispersion liquid containing the surfactant, the metal type single-walled carbon nanotubes have positive charges, and the semiconductor type single-walled carbon nanotubes have extremely weak negative charges.

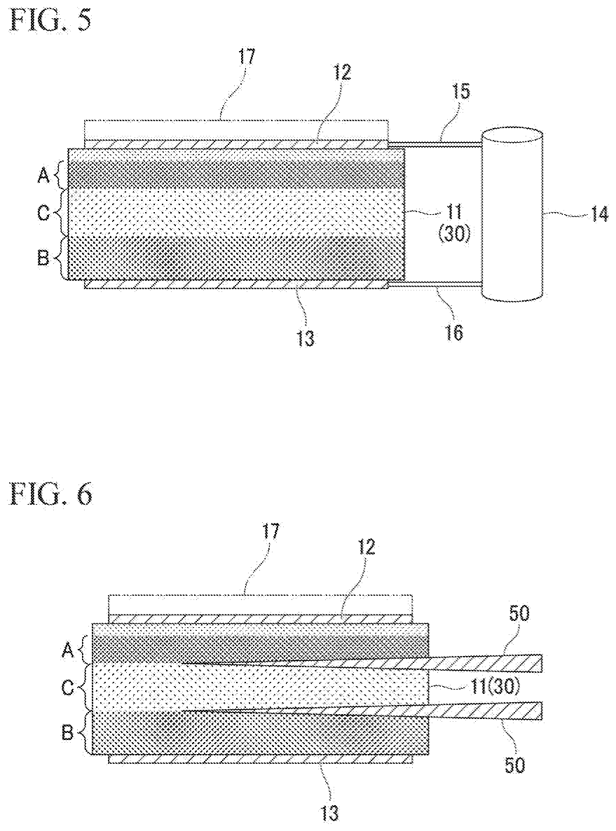

Accordingly, when a direct current voltage is applied to the first electrode 12 and the second electrode 13, in the mixture of the single-walled carbon nanotube contained in the single-walled carbon nanotube dispersion liquid, the metal type single-walled carbon nanotubes are moved toward the first electrode 12 (the negative electrode), and the semiconductor type single-walled carbon nanotubes are moved toward the second electrode 13 (the positive electrode). As a result, as shown in FIG. 5, the single-walled carbon nanotube dispersion liquid is separated into three phases of a dispersion liquid phase A, a dispersion liquid phase B and a dispersion liquid phase C. The dispersion liquid phase A is a dispersion liquid phase having a relatively large content of the metal type single-walled carbon nanotubes. The dispersion liquid phase B is a dispersion liquid phase having a relatively large content of the semiconductor type single-walled carbon nanotubes. The dispersion liquid phase C is a dispersion liquid phase formed between the dispersion liquid phase A and the dispersion liquid phase B and having a relatively small content of the metal type single-walled carbon nanotubes and the semiconductor type single-walled carbon nanotubes.

In the embodiment, the dispersion liquid phase A is formed on the side of the first electrode 12, and the dispersion liquid phase B is formed on the side of the second electrode 13.

A direct current voltage applied to the first electrode 12 and the second electrode 13 is not particularly limited, and is appropriately adjusted according to a distance between the first electrode 12 and the second electrode 13, a content of the mixture of the single-walled carbon nanotubes in the single-walled carbon nanotube dispersion liquid, or the like.

When water or heavy water is used as the dispersion medium of the single-walled carbon nanotube dispersion liquid, the direct current voltage applied to the first electrode 12 and the second electrode 13 is an arbitrary value of larger than 0 V and equal or less than 1000 V.

For example, when a distance between the first electrode 12 and the second electrode 13 (a distance between electrodes) is 30 cm, the direct current voltage applied to the first electrode 12 and the second electrode 13 is preferably 15 V or more and 450 V or less, and more preferably 30 V or more and 300 V or less.

When the direct current voltage applied to the first electrode 12 and the second electrode 13 is equal to or greater than 15 V, a pH gradient of the single-walled carbon nanotube dispersion liquid is formed in the porous structure 11, and the metal type single-walled carbon nanotubes and the semiconductor type single-walled carbon nanotubes contained in the single-walled carbon nanotube dispersion liquid can be separated. Meanwhile, when the direct current voltage applied to the first electrode 12 and the second electrode 13 is equal to or less than 450 V, an influence by electrolysis of water or heavy water is minimized.

In addition, when the direct current voltage is applied to the first electrode 12 and the second electrode 13, an electric field between the first electrode 12 and the second electrode 13 is preferably 0.5 V/cm or more and 15 V/cm or less, and more preferably 1 V/cm or more and 10 V/cm or less.

When the electric field between the first electrode 12 and the second electrode 13 is equal to or greater than 0.5 V/cm, a pH gradient of the single-walled carbon nanotube dispersion liquid is formed in the porous structure 11, and the metal type single-walled carbon nanotubes and the semiconductor type single-walled carbon nanotubes contained in the single-walled carbon nanotube dispersion liquid can be separated. Meanwhile, when the electric field between the first electrode 12 and the second electrode 13 is equal to or less than 15 V/cm, an influence by electrolysis of water or heavy water is minimized.

In the separation process, a temperature of the single-walled carbon nanotube dispersion liquid held in the porous structure 11 is not particularly limited as long as the temperature is a temperature at which the dispersion medium in the single-walled carbon nanotube dispersion liquid is not degenerated or evaporated.

When the separation of the metal type single-walled carbon nanotubes and the semiconductor type single-walled carbon nanotubes is performed, the nanocarbon dispersion liquid having a large content of the metal type single-walled carbon nanotubes becomes black, and the nanocarbon dispersion liquid is colored according to a diameter and chirality of the single-walled carbon nanotubes. Here, the separation state of the metal type single-walled carbon nanotubes and the semiconductor type single-walled carbon nanotubes is visually checked using a color of the porous structure 11 as a background. When the separation is visually checked, the separation process is terminated at the time when the color of the single-walled carbon nanotube dispersion liquid is not changed.

A state of the coloration in the single-walled carbon nanotube dispersion liquid can also be automated using image recognition by a camera, measurement of an optical absorption spectrum, or the like.

Next, in the collecting process, a process of collecting the metal type single-walled carbon nanotubes and the semiconductor type single-walled carbon nanotubes contained in the single-walled carbon nanotube dispersion liquid is performed. That is, the separated dispersion liquid phase A and the separated dispersion liquid phase B are collected (preparatively isolated) from the porous structure 11.

The collecting method of the dispersion liquid phase A and the dispersion liquid phase B is not particularly limited, and may be any method as long as the collecting method is a method in which the dispersion liquid phase A and the dispersion liquid phase B are not dispersed and mixed.

As the collecting method, for example, the following method is used.

As the collecting method, for example, as shown in FIG. 6, a method using a cutting blade 50 is exemplified.

In the collecting method, the porous structure 11 is cut perpendicular to a height direction thereof by the cutting blade 50 and the porous structure 11 is split into three parts in the height direction while the direct current voltage is applied to the first electrode 12 and the second electrode 13. That is, the porous structure 11 is split into a portion corresponding to the dispersion liquid phase A, a portion corresponding to the dispersion liquid phase B and a portion corresponding to the dispersion liquid phase C. In addition, simultaneously with the splitting, in the porous structure 11 split into three parts, a partition plate or the like is inserted between the portion corresponding to the dispersion liquid phase A and the portion corresponding to the dispersion liquid phase C, and a partition plate or the like is inserted between the portion corresponding to the dispersion liquid phase C and the portion corresponding to the dispersion liquid phase B. Then, the portion corresponding to the dispersion liquid phase A, the portion corresponding to the dispersion liquid phase B and the portion corresponding to the dispersion liquid phase C are each collected. Further, the cutting blade 50 may be used as a part of the partition plate.

The collected dispersion liquid is held in the porous structure 11 again, and as described above, an operation of separating the metal type single-walled carbon nanotubes and the semiconductor type single-walled carbon nanotubes contained in the single-walled carbon nanotube dispersion liquid through electrophoresis may be repeatedly performed. Accordingly, it is possible to obtain the metal type single-walled carbon nanotubes and the semiconductor type single-walled carbon nanotubes having higher purity.

Separation efficiency of the collected dispersion liquid can be estimated through a method such as a microscopic Raman spectrometric method (a variation in Raman spectrum in a radial breathing mode (RBM) region, a variation in a Raman spectrum shape of a Breit-Wigner-Fano (BWF) region), ultraviolet-visible near infrared absorptiometry (a variation in peak shape of an absorption spectrum), and the like. In addition, the separation efficiency of the dispersion liquid can be estimated even by estimating an electrical property of the single-walled carbon nanotube. For example, the separation efficiency of the dispersion liquid can be estimated by fabricating an electric field effect transistor and measuring transistor characteristics thereof.

According to the nanocarbon separation method using the nanocarbon separation device 10 of the embodiment, a carrier capable of containing and independently holding the single-walled carbon nanotube dispersion liquid in the porous structure 11 is constructed by holding the single-walled carbon nanotube dispersion liquid in the porous structure 11. Then, the separation by the single-walled carbon nanotube dispersion liquid can be immediately started by causing the electrode to come into contact with a carrying surface thereof and applying a voltage thereto. In addition, even in collection after the separation, the collection can be rapidly performed without being affected by the disturbance of the solution.

In addition, according to the nanocarbon separation method using the nanocarbon separation device 10 of the embodiment, after the separating operation of the metal type single-walled carbon nanotubes and the semiconductor type single-walled carbon nanotubes, the separated metal type single-walled carbon nanotubes and the separated semiconductor type single-walled carbon nanotubes can be efficiently collected from the porous structure 11.

Further, in the nanocarbon separation method of the embodiment, the case in which the mixture of the single-walled carbon nanotubes is separated into the metal type single-walled carbon nanotubes and the semiconductor type single-walled carbon nanotubes has been exemplified. However, the nanocarbon separation method of the embodiment is not particularly limited thereto. The nanocarbon separation method of the embodiment may be performed as, for example, a single-walled carbon nanotube purification method of separating the metal type single-walled carbon nanotubes and the semiconductor type single-walled carbon nanotubes in the porous structure 11, and then collecting only the single-walled carbon nanotube having a targeted property.

### Second Embodiment

### Nanocarbon Separation Device

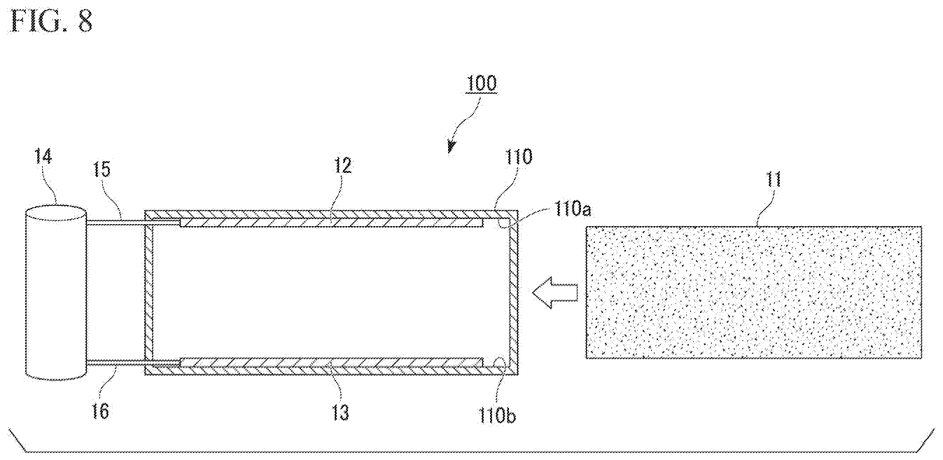

FIG. 8 is a schematic diagram showing a nanocarbon separation device of an embodiment. Further, in FIG. 8, the same components as those of the nanocarbon separation device of the first embodiment shown in FIG. 1 are designated by the same reference numerals, and overlapping description thereof will be omitted.

The nanocarbon separation device 100 of the embodiment includes the porous structure 11, the first electrode 12 disposed to come into contact with the upper end 11a of the porous structure 11, the second electrode 13 disposed to come into contact with the lower end 11b of the porous structure 11, and a housing 110 configured to accommodate the porous structure 11. In addition, the nanocarbon separation device 100 of the embodiment may include the direct current power supply 14. The direct current power supply 14 is electrically connected to the first electrode 12 via the cable 15, and electrically connected to the second electrode 13 via the cable 16.

In the nanocarbon separation device 100 of the embodiment, the first electrode 12 is provided on an upper surface 110a in the housing 110, and the second electrode 13 is provided on a lower surface 110b in the housing 110.

That is, in the nanocarbon separation device 100 of the embodiment, as in the nanocarbon separation device 10 of the first embodiment, the first electrode 12 and the second electrode 13 are not fixed to the porous structure 11.

A form in the housing 110 is substantially the same as the external form of the porous structure 11. Accordingly, when the porous structure 11 is disposed between the first electrode 12 and the second electrode 13 in the housing 110, the first electrode 12 comes into contact with the upper end 11a of the porous structure 11, and the second electrode 13 comes into contact with the lower end 11b of the porous structure 11. In addition, the porous structure 11 is held between the first electrode 12 and the second electrode 13 such that the porous structure 11 is attachable to and detachable from the housing 110.

A material of the housing 110 is not particularly limited as long as the material is stable with respect to the nanocarbon dispersion liquid and is an insulating material.

In the nanocarbon separation device 100 of the embodiment, while the case in which the first electrode 12 is the negative electrode and the second electrode 13 is the positive electrode has been described, the nanocarbon separation device 100 of the embodiment is not limited thereto. In the nanocarbon separation device 100 of the embodiment, the first electrode 12 may be a positive electrode, and the second electrode 13 may be a negative electrode.

According to the nanocarbon separation device 100 of the embodiment, the porous structure 11 configured to hold the nanocarbon dispersion liquid is provided between the first electrode 12 and the second electrode 13. Accordingly, for example, in the nanocarbon separation method, which will be described below, the process of separation the metal type nanocarbons and the semiconductor type nanocarbons contained in the nanocarbon dispersion liquid can be realized as follows. That is, the separation can be immediately started using a method of constructing a carrier capable of containing and independently holding the nanocarbon dispersion liquid in the porous structure 11 by holding the nanocarbon dispersion liquid in the porous structure 11, and applying a voltage to a carrying surface thereof. In addition, even in collection after the separation, the collection can be rapidly performed without being affected by the disturbance of the solution. As a result, the disturbance or the like when an increase in capacity and improvement of an introduction speed are performed can be minimized, and efficient separation can be rapidly performed.

### Nanocarbon Separation Method

An action of the nanocarbon separation device 100 will be described while describing the nanocarbon separation method using the nanocarbon separation device 100 with reference to FIGS. 8 to 13. Further, in FIGS. 8 to 13, the same components as those of the nanocarbon separation device of the first embodiment shown in FIG. 1 and the nanocarbon separation method of the first embodiment shown in FIGS. 2 to 6 are designated by the same reference numerals, and overlapping description thereof will be omitted.

The nanocarbon separation method of the embodiment has a holding process, a contact process and a separation process. In the holding process, the nanocarbon dispersion liquid is held in the porous structure 11. In the contact process, the first electrode 12 comes into contact with at least a part of the upper end 11a of the porous structure 11, and the second electrode 13 comes into contact with at least a part of the lower end 11b of the porous structure 11. In the separation process, a direct current voltage is applied between the first electrode 12 and the second electrode 13, the metal type nanocarbon contained in the nanocarbon dispersion liquid are moved toward the first electrode 12 and the semiconductor type nanocarbons contained in the nanocarbon dispersion liquid are moved toward the second electrode 13, and thus, the metal type nanocarbons and the semiconductor type nanocarbons are separated.

In addition, the nanocarbon separation method of the embodiment may have a process of collecting the metal type nanocarbons and the semiconductor type nanocarbons contained in the nanocarbon dispersion liquid after the separation process (hereinafter, referred to as “a collecting process”).

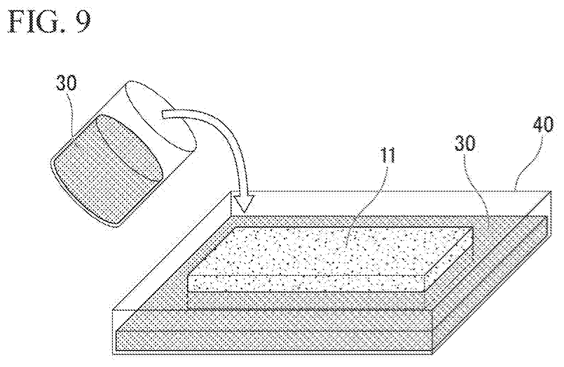

First, as in the first embodiment, the single-walled carbon nanotube dispersion liquid (the nanocarbon dispersion liquid 30 shown in FIG. 9) is prepared.

Next, as in the first embodiment, in the holding process, as shown in FIG. 9, a process of holding the single-walled carbon nanotube dispersion liquid in the porous structure 11 is performed (ST1 in FIG. 7).

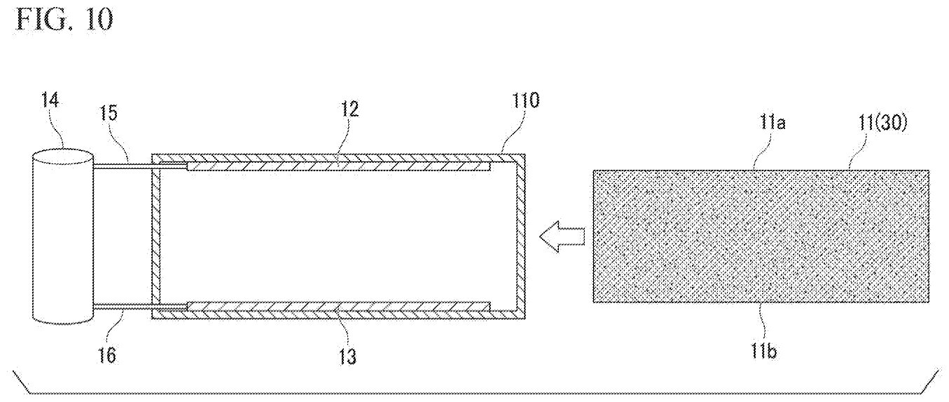

Next, in the contact process, as shown in FIG. 10, the porous structure 11 is disposed between the first electrode 12 and the second electrode 13 in the housing 110. Accordingly, the first electrode 12 comes into contact with at least a part of the upper end 11a of the porous structure 11, and the second electrode 13 comes into contact with at least a part of the lower end 11b of the porous structure 11 (ST2 in FIG. 7).

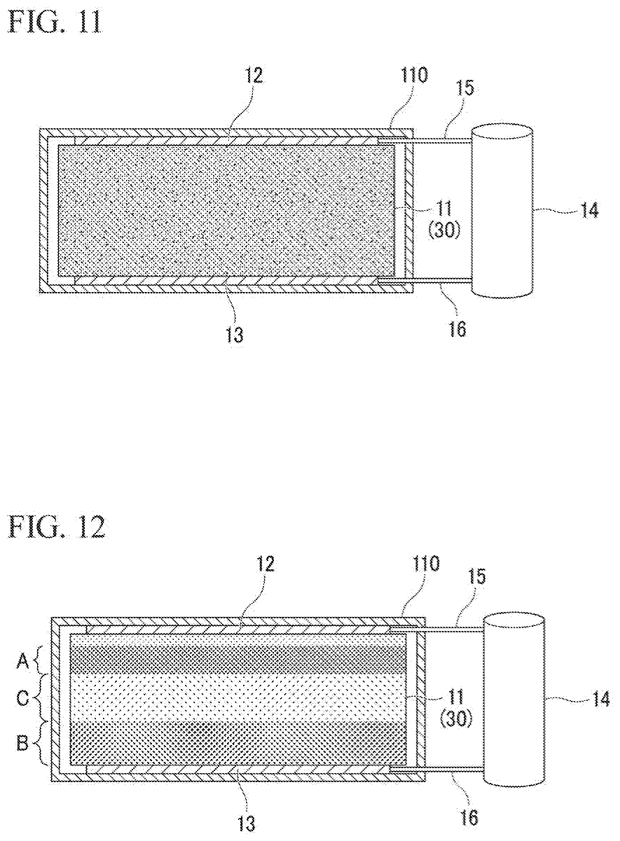

Next, as in the first embodiment, the separation process is performed. In the separation process, as shown in FIG. 11, the metal type single-walled carbon nanotubes contained in the single-walled carbon nanotube dispersion liquid are moved toward the first electrode 12 and the semiconductor type single-walled carbon nanotubes contained in the single-walled carbon nanotube dispersion liquid are moved toward the second electrode 13 through electrophoresis. Accordingly, the metal type single-walled carbon nanotubes and the semiconductor type single-walled carbon nanotubes are separated (ST3 in FIG. 7).

When a direct current voltage is applied to the first electrode 12 and the second electrode 13, as in the first embodiment, as shown in FIG. 12, the single-walled carbon nanotube dispersion liquid is separated into three phases of the dispersion liquid phase A, the dispersion liquid phase B and the dispersion liquid phase C. The dispersion liquid phase A is a dispersion liquid phase having a relatively large content of the metal type single-walled carbon nanotubes. The dispersion liquid phase B is a dispersion liquid phase having a relatively large content of the semiconductor type single-walled carbon nanotube. The dispersion liquid phase C is a dispersion liquid phase formed between the dispersion liquid phase A and the dispersion liquid phase B and having a relatively small content of the metal type single-walled carbon nanotubes and the semiconductor type single-walled carbon nanotubes.

After the separation process is terminated, in the collecting process, a process of collecting the metal type single-walled carbon nanotubes and the semiconductor type single-walled carbon nanotubes contained in the single-walled carbon nanotube dispersion liquid is performed. That is, the separated dispersion liquid phase A and the separated the dispersion liquid phase B are collected (preparatively isolated) from the porous structure 11.

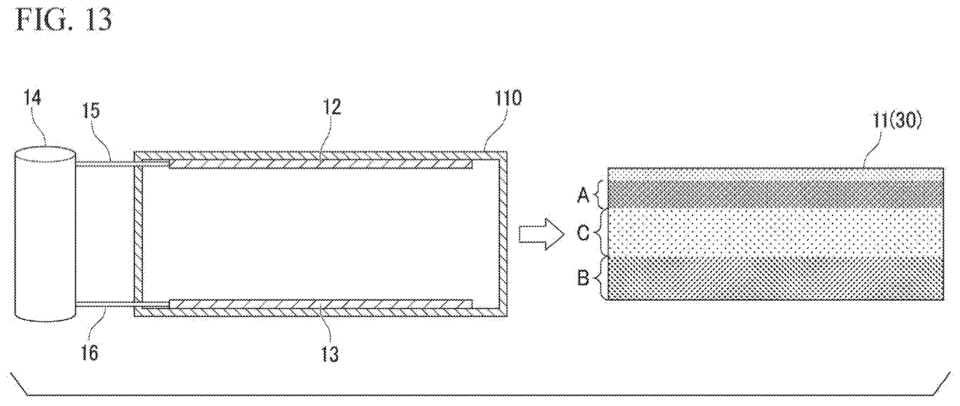

In the nanocarbon separation method of the embodiment, in collecting the dispersion liquid phase A and the dispersion liquid phase B, as shown in FIG. 13, the porous structure 11 containing the dispersion liquid phase A, the dispersion liquid phase B and the dispersion liquid phase C is separated from the housing 110.

Next, as in the first embodiment, the porous structure 11 is split into a portion corresponding to the dispersion liquid phase A, a portion corresponding to the dispersion liquid phase B, and a portion corresponding to the dispersion liquid phase C. In addition, simultaneously with the splitting, in the porous structure 11 split into three parts, a partition plate or the like is inserted between the portion corresponding to the dispersion liquid phase A and the portion corresponding to the dispersion liquid phase C, and a partition plate or the like is inserted between the portion corresponding to the dispersion liquid phase C and the portion corresponding to the dispersion liquid phase B. Then, the portion corresponding to the dispersion liquid phase A, the portion corresponding to the dispersion liquid phase B and the portion corresponding to the dispersion liquid phase C are each collected.

In addition, as in the first embodiment, the collected dispersion liquid is held in the porous structure 11 again, and an operation of separating the metal type single-walled carbon nanotubes and the semiconductor type single-walled carbon nanotubes contained in the single-walled carbon nanotube dispersion liquid through the electrophoresis is repeatedly performed.

Separation efficiency of the collected dispersion liquid can be estimated as in the first embodiment.

According to the nanocarbon separation method using the nanocarbon separation device 100 of the embodiment, a carrier capable of containing and independently holding the single-walled carbon nanotube dispersion liquid in the porous structure 11 is constructed by holding the single-walled carbon nanotube dispersion liquid in the porous structure 11. Then, the separation by the single-walled carbon nanotube dispersion liquid can be immediately started by causing the electrode to come into contact with the carrying surface and applying a voltage thereto. In addition, even in collection after the separation, the collection can be rapidly performed without being affected by the disturbance of the solution.

In addition, according to the nanocarbon separation method using the nanocarbon separation device 100 of the embodiment, after the operation of separating the metal type single-walled carbon nanotubes and the semiconductor type single-walled carbon nanotubes is terminated, the separated metal type single-walled carbon nanotubes or the separated semiconductor type single-walled carbon nanotubes can be efficiently collected from the porous structure 11.

Further, in the nanocarbon separation method of the embodiment, the case in which the mixture of the single-walled carbon nanotube is separated into the metal type single-walled carbon nanotubes and the semiconductor type single-walled carbon nanotubes has been exemplified. However, the nanocarbon separation method of the embodiment is not particularly limited. The nanocarbon separation method of the embodiment may also be performed as a single-walled carbon nanotube purification method of separating the single-walled carbon nanotubes into the metal type single-walled carbon nanotubes and the semiconductor type single-walled carbon nanotubes in the porous structure 11, and then collecting only the single-walled carbon nanotube having a targeted property.

### Third Embodiment

### Nanocarbon Separation Device

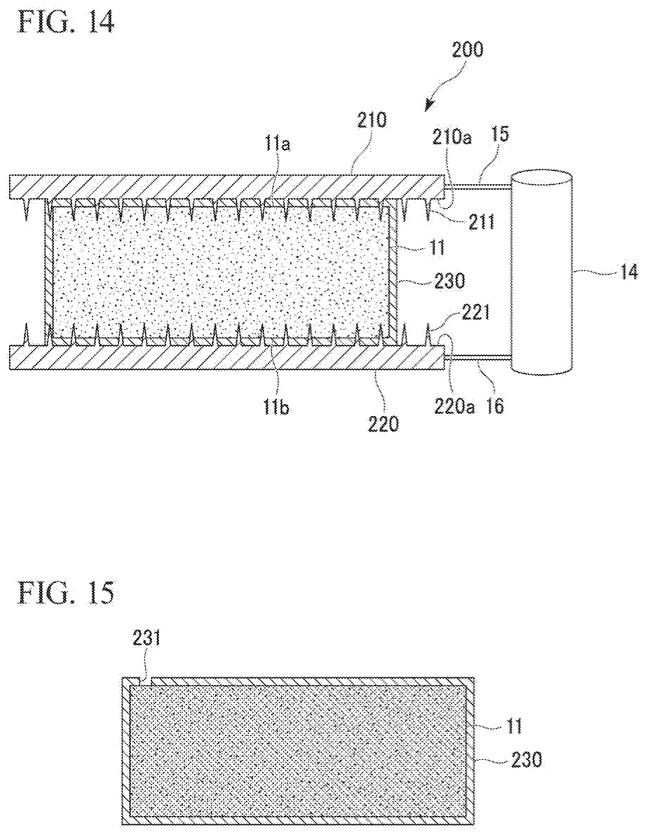

FIG. 14 is a schematic diagram showing a nanocarbon separation device of an embodiment. Further, in FIG. 14, the same components as those of the nanocarbon separation device of the first embodiment shown in FIG. 1 are designated by the same reference numerals and overlapping description thereof will be omitted.

A nanocarbon separation device 200 of the embodiment includes a porous structure 11, a first electrode 210 disposed to come into contact with the upper end 11a of the porous structure 11, and a second electrode 220 disposed to come into contact with the lower end 11b of the porous structure 11. In the nanocarbon separation device 200 of the embodiment, the porous structure 11 is coated with a coating material 230. In addition, the nanocarbon separation device 200 of the embodiment may include a direct current power supply 14. The direct current power supply 14 is electrically connected to the first electrode 210 via a cable 15, and electrically connected to the second electrode 220 via a cable 16.

In the nanocarbon separation device 200 of the embodiment, the first electrode 210 is a negative electrode, and the second electrode 220 is a positive electrode.

In the nanocarbon separation device 200 of the embodiment, a plurality of needle-shaped protrusions (terminals) 211 are provided on a surface 210a of the first electrode 210 in contact with the upper end 11a of the porous structure 11. That is, the first electrode 210 forms a pinholder-shaped structure. Similarly, a plurality of needle-shaped protrusions (terminals) 221 are provided on a surface 220a of the second electrode 220 in contact with the lower end 11b of the porous structure 11. That is, the second electrode 220 forms a pinholder-shaped structure.

The first electrode 210 is fixed to the upper end 11a of the porous structure 11 when the protrusions 211 reaches the porous structure 11 through the coating material 230. Similarly, the second electrode 220 is fixed to the lower end 11b of the porous structure 11 when the protrusions 221 reaches the porous structure 11 through the coating material 230.

Structures of the first electrode 210 and the second electrode 220 are not particularly limited, and the shape, size, or the like of the porous structure 11 is appropriately selected.

The first electrode 210 and the second electrode 220 are formed as the same material as that of the first electrode 12 and the second electrode 13.

The coating material 230 is a film-shaped material configured to cover the entire porous structure 11. The coating material 230 may be any material as long as the material is stable with respect to the nanocarbon dispersion liquid and capable of prevent evaporation of the liquid. As an example of the coating material that prevents evaporation of the liquid, any material that does not allow the solvent to pass therethrough can be used. As the coating material, for example, a polymeric film such as a polyvinylchloride film, a polyvinylidene chloride film, a polypropylene film, a polyacrylonitrile film, a nylon film, a polyethylene terephthalate film, a polyethylene naphthalate film, or the like, a paper such as an oil paper, a parafilm, or the like, a rubber film, a rubber tube, a housing or a glass tube formed of a glass film, a thin plastic housing, or the like, may be used. In addition, a portion of the coating material 230 configured to cover the upper end 11a and the lower end 11b of the porous structure 11 can also be formed of a conductive film. As the conductive film, for example, an anisotropic conductive film or the like formed in a film shape using a mixture of fine metal grains with a binding material such as a thermosetting resin or the like is exemplified. As a result, adhesion of the first electrode 210 with respect to the upper end 11a of the porous structure 11 can be increased, and adhesion of the second electrode 220 with respect to the lower end 11b of the porous structure 11 can be increased.

In the nanocarbon separation device 200 of the embodiment, while the case in which the first electrode 210 is the negative electrode and the second electrode 220 is the positive electrode has been exemplified, the nanocarbon separation device 200 of the embodiment is not particularly limited thereto. In the nanocarbon separation device 200 of the embodiment, the first electrode 210 may be a positive electrode, and the second electrode 220 may be a negative electrode.

According to the nanocarbon separation device 200 of the embodiment, the porous structure 11 configured to hold the nanocarbon dispersion liquid is provided between the first electrode 210 and the second electrode 220. The nanocarbon separation method described below can be realized as follows in the process of separating the metal type nanocarbons and the semiconductor type nanocarbons contained in the nanocarbon dispersion liquid. That is, when a method of constructing a carrier capable of containing and independently holding the nanocarbon dispersion liquid in the porous structure 11 by holding the nanocarbon dispersion liquid in the porous structure 11 and applying a voltage to a carrying surface thereof is used, the separation can be immediately started. In addition, even in collection after the separation, the collection can be rapidly performed without being affected by the disturbance of the solution. As a result, the disturbance or the like when an increase in capacity and improvement of an introduction speed are performed can be minimized, and efficient separation can be rapidly performed.

### Nanocarbon Separation Method

An action of the nanocarbon separation device 200 will be described while describing the nanocarbon separation method using the nanocarbon separation device 200 with respect to FIGS. 14 to 18. Further, in FIGS. 14 to 18, the same components as those of the nanocarbon separation device of the first embodiment shown in FIG. 1 and the nanocarbon separation method of the first embodiment shown in FIGS. 2 to 6 are designated by the same reference numerals and overlapping description thereof will be omitted.

The nanocarbon separation method of the embodiment has a holding process, a contact process and a separation process. In the holding process, the nanocarbon dispersion liquid is held in the porous structure 11. In the contact process, the first electrode 210 comes into contact with at least a part of the upper end 11a of the porous structure 11, and the second electrode 220 comes into contact with at least a part of the lower end 11b of the porous structure 11. In the separation process, a direct current voltage is applied between the first electrode 210 and the second electrode 220, the metal type nanocarbons contained in the nanocarbon dispersion liquid are moved toward the first electrode 210 and the semiconductor type nanocarbons contained in the nanocarbon dispersion liquid are moved toward the second electrode 220, and thus, the metal type nanocarbons and the semiconductor type nanocarbons are separated.

In addition, the nanocarbon separation method of the embodiment may have a process of collecting the metal type nanocarbons and the semiconductor type nanocarbons contained in the nanocarbon dispersion liquid after the separation process (a collecting process).

First, as in the first embodiment, the single-walled carbon nanotube dispersion liquid is prepared.

Next, in the holding process, a process of holding the single-walled carbon nanotube dispersion liquid in the porous structure 11 is performed (ST1 in FIG. 7).

In the holding process, for example, as shown in FIG. 15, the single-walled carbon nanotube dispersion liquid is injected into the coating material 230 from a filler port 231 provided in the coating material 230 in advance. Then, the single-walled carbon nanotube dispersion liquid infiltrates into the porous structure 11 in the coating material 230, and the single-walled carbon nanotube dispersion liquid is held in the porous structure 11. After holding of the single-walled carbon nanotube dispersion liquid in the porous structure 11 is terminated, the filler port 231 is sealed.

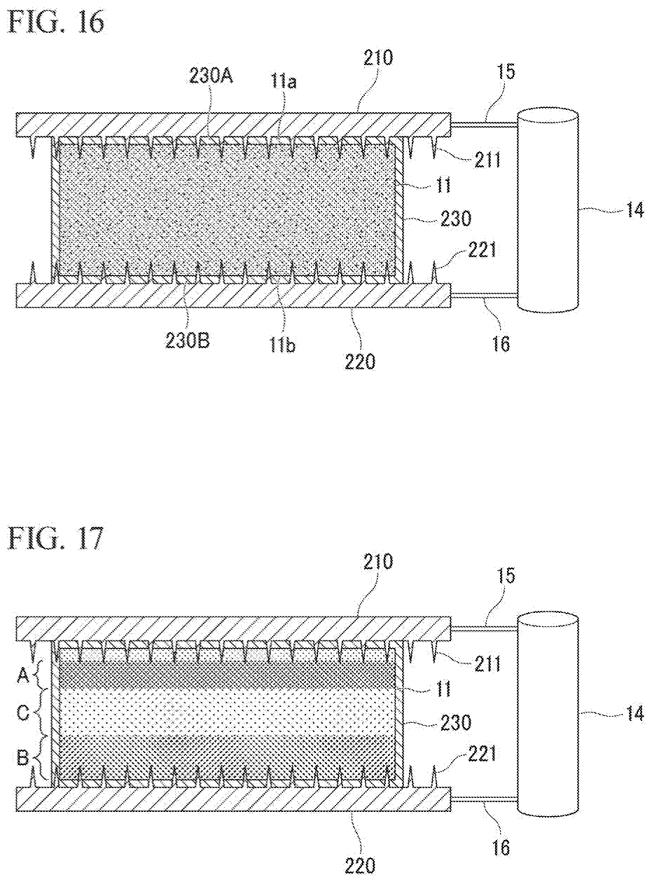

Next, in the contact process, as shown in FIG. 16, the protrusions 211 of the first electrode 210 reach the porous structure 11 through a region 230A of the coating material 230 that covers the upper end 11a of the porous structure 11. Accordingly, the first electrode 210 comes into contact with at least a part of the upper end 11a of the porous structure 11. Accordingly, the first electrode 210 is fixed to the upper end 11a of the porous structure 11. Similarly, the protrusions 221 of the second electrode 220 reach the porous structure 11 through a region 230B of the coating material 230 that covers the lower end 11b of the porous structure 11. Accordingly, the second electrode 220 comes into contact with at least a part of the lower end 11b of the porous structure 11 (ST2 in FIG. 7). Accordingly, the second electrode 220 is fixed to the lower end 11b of the porous structure 11.

Next, as in the first embodiment, in the separation process, as shown in FIG. 17, a process of moving the metal type single-walled carbon nanotubes contained in the single-walled carbon nanotube dispersion liquid toward the first electrode 210 and moving the semiconductor type single-walled carbon nanotubes contained in the single-walled carbon nanotube dispersion liquid toward the second electrode 220 through electrophoresis is performed. The metal type single-walled carbon nanotubes and the semiconductor type single-walled carbon nanotubes are separated (ST3 in FIG. 7).

When a direct current voltage is applied to the first electrode 210 and the second electrode 220, as in the first embodiment, as shown in FIG. 17, the single-walled carbon nanotube dispersion liquid is separated into three phases of a dispersion liquid phase A, a dispersion liquid phase B and a dispersion liquid phase C. The dispersion liquid phase A is a dispersion liquid phase having a relatively large content of the metal type single-walled carbon nanotubes. The dispersion liquid phase B is a dispersion liquid phase having a relatively large content of the semiconductor type single-walled carbon nanotubes. The dispersion liquid phase C is a dispersion liquid phase formed between the dispersion liquid phase A and the dispersion liquid phase B having a relatively small content of the metal type single-walled carbon nanotubes and the semiconductor type single-walled carbon nanotubes.

After the separation process is terminated, in the collecting process, the metal type single-walled carbon nanotubes and the semiconductor type single-walled carbon nanotubes contained in the single-walled carbon nanotube dispersion liquid are collected. That is, the separated dispersion liquid phase A and the separated dispersion liquid phase B are collected (preparatively isolated) from the porous structure 11.

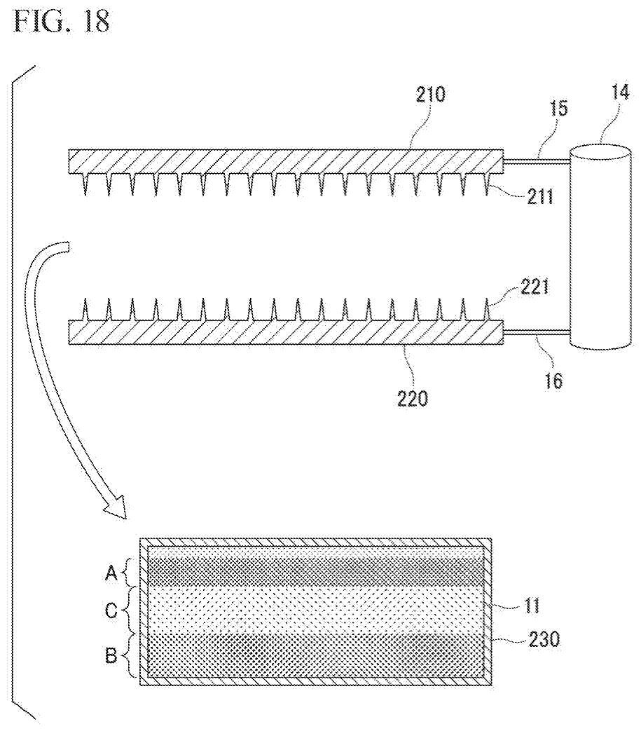

In the nanocarbon separation method of the embodiment, in collecting the dispersion liquid phase A and the dispersion liquid phase B, as shown in FIG. 18, the first electrode 210 and the second electrode 220 are separated from the porous structure 11 coated with the coating material 230.

Next, as in the first embodiment, the porous structure 11 is split into a portion corresponding to the dispersion liquid phase A, a portion corresponding to the dispersion liquid phase B, and a portion corresponding to the dispersion liquid phase C. In addition, simultaneously with the splitting, in the porous structure 11 split into three parts, a partition plate or the like is inserted between the portion corresponding to the dispersion liquid phase A and the portion corresponding to the dispersion liquid phase C, and a partition plate or the like is inserted between the portion corresponding to the dispersion liquid phase C and the portion corresponding to the dispersion liquid phase B. Then, the portion corresponding to the dispersion liquid phase A, the portion corresponding to the dispersion liquid phase B, and the portion corresponding to the dispersion liquid phase C are each collected.

In addition, as in the first embodiment, the collected dispersion liquid is held in the porous structure 11 again, and an operation of separating the metal type single-walled carbon nanotubes and the semiconductor type single-walled carbon nanotubes contained in the single-walled carbon nanotube dispersion liquid through electrophoresis may be repeatedly performed.

As in the first embodiment, separation efficiency of the collected dispersion liquid can be estimated.

According to the nanocarbon separation method using the nanocarbon separation device 200 of the embodiment, the method can be realized as follows by holding the single-walled carbon nanotube dispersion liquid in the porous structure 11. That is, the separation by the single-walled carbon nanotube dispersion liquid can be immediately started using a method of constructing a carrier capable of containing and independently holding the single-walled carbon nanotube dispersion liquid in the porous structure 11, causing the electrodes to come into contact with a carrying surface thereof and applying a voltage thereto. In addition, even in collection after the separation, the collection can be rapidly performed without being affected by the disturbance of the solution.

According to the nanocarbon separation method using the nanocarbon separation device 200 of the embodiment, after the operation of separating the metal type single-walled carbon nanotubes and the semiconductor type single-walled carbon nanotubes is terminated, the separated metal type single-walled carbon nanotubes or the separated semiconductor type single-walled carbon nanotubes can be efficiently collected from the porous structure 11.

Further, in the nanocarbon separation method of the embodiment, the case in which the mixture of the single-walled carbon nanotubes is separated into the metal type single-walled carbon nanotubes and the semiconductor type single-walled carbon nanotubes has been exemplified. However, the nanocarbon separation method of the embodiment is not limited thereto. The nanocarbon separation method of the embodiment may be performed as a single-walled carbon nanotube purification method of separating the metal type single-walled carbon nanotubes and the semiconductor type single-walled carbon nanotubes in the porous structure 11, and then collecting only the single-walled carbon nanotubes having a targeted property.

### Fourth Embodiment

### Nanocarbon Separation Device

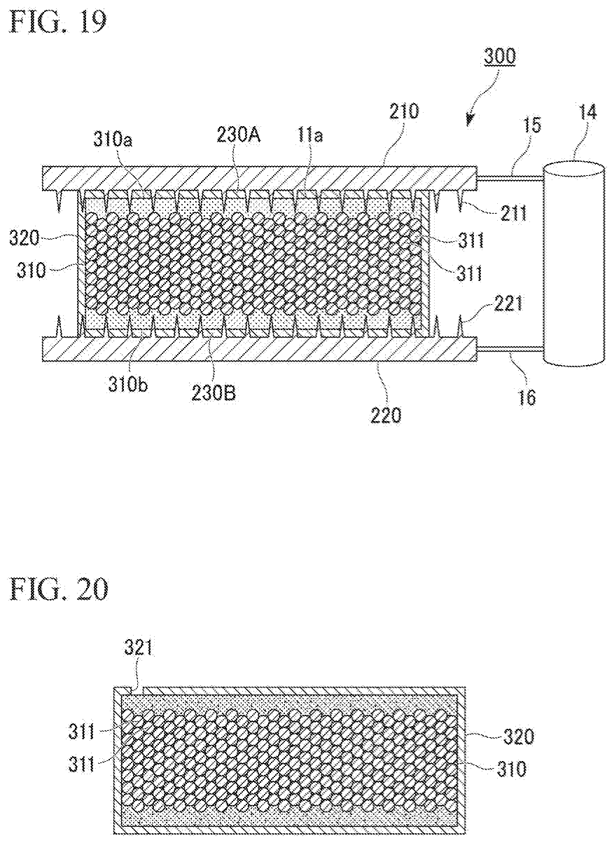

FIG. 19 is a schematic diagram showing a nanocarbon separation device of an embodiment. Further, in FIG. 19, the same components as those of the nanocarbon separation device of the first embodiment shown in FIG. 1 and the nanocarbon separation device of the third embodiment shown in FIG. 14 are designated by the same reference numerals and overlapping description thereof will be omitted.

A nanocarbon separation device 300 of the embodiment includes a porous structure 310, a first electrode 210 disposed to come into contact with an upper end 310a of the porous structure 310, and a second electrode 220 disposed to come into contact with a lower end 310b of the porous structure 310. In the nanocarbon separation device 300 of the embodiment, the porous structure 310 is coated with a coating material 320. In addition, the nanocarbon separation device 300 of the embodiment may include a direct current power supply 14. The direct current power supply 14 is electrically connected to the first electrode 210 via the cable 15, and electrically connected to the second electrode 220 via the cable 16.

In the nanocarbon separation device 300 of the embodiment, the porous structure 310 is constituted by a plurality of particles 311.

The porous structure 310 is constituted by the plurality of particles 311 filled in the coating material 320. The particles 311 are not particularly limited as long as the particles 311 have a shape in which gaps occur between the particles when the particles are filled in the coating material 320 most closely. As the particles 311, for example, spherical particles, caltrop-shape particles, tetrapod (trademark)-shaped particles, or the like, are exemplified.

When the coating material 320 is filled with such particles 311, gaps occurs between the particles 311, and the porous structure 310 is formed. In this way, the inside of the coating material 320 is partitioned into a plurality of spaces by the porous structure 310 by forming the porous structure 310 constituted by the plurality of particles 311 in the coating material 320.

A material of the particles 311 is not particularly limited as long as the material is stable with respect to the nanocarbon dispersion liquid and is an insulating material. As a material of the particles 311, for example, glass, quartz, acryl resin, or the like, is exemplified.

A filler content of the particles 311 with respect to the coating material 320 is not particularly limited and appropriately set according to a quantity (a volume) of the nanocarbon dispersion liquid accommodated in the coating material 320.

Further, forms of the pores of the porous structure 310 are irregular shapes, for example, spherical shapes, spheroidal shapes, or the like. For this reason, the inner diameters of the pores in the porous structure 310 are diameters of spherical bodies when the pores are formed in spherical shapes, large diameters of spheroidal shapes when the pores are formed in spheroidal shapes, and lengths of the longest portion of the shape when the pores are formed in shapes other than spherical shapes and spheroidal shapes.

Sizes of the pores of the porous structure 310 are obtained in the same manner as the sizes of the pores of the above-mentioned porous structure 11.

The porous structure 310, i.e., the particles 311 that constitute the porous structure 310 are preferably transparent, milky-white translucent (white that can see through the back), or milky-white (white that is not transparent, translucent), in order to easily allow a separation state of the metal type nanocarbons and the semiconductor type nanocarbons contained in the nanocarbon dispersion liquid to be checked.

An outer diameter of the particles 311 (a maximum strength of the particles 311) is not particularly limited and appropriately set according to a content or the like of the mixture of the nanocarbon in the nanocarbon dispersion liquid accomodated in the coating material 320.

A porosity degree (porosity) of the porous structure 310 is a proportion occupied by the gaps occurring between the particles 311 with respect to a total volume of the porous structure 310. A porosity degree of the porous structure 310 is represented by the following formula (4).

a2/A2×100 (4)

That is, the porosity degree of the porous structure 310 is represented as a percentage of a ratio between a total volume a2 of the gaps of the porous structure 310 and a total volume A2 of the porous structure 310 including the gaps.

As a method of obtaining the porosity degree of the porous structure 310, for example, a method of obtaining an apparent specific gravity d2 of the porous structure 310 including the gaps and a true specific gravity D2 of the porous structure 310 including the gaps and calculating the porosity degree of the porous structure 310 on the basis of the specific gravity thereof is exemplified. In this method, the porosity degree of the porous structure 310 is calculated on the basis of the following formula (5)

(D2−d2)/D2×100 (5)

As a method of obtaining the sizes of the cavities of the porous structure 310, for example, a method of observing the porous structure 310 using an optical microscope or a scanning electron microscope and actually measuring the sizes of the pores on the basis of microscopic images thereof, or the like, is exemplified.

As the coating material 320, the same material as the coating material 230 is used. In the coating material 320, portions that the upper end 310a and the lower end 310b of cover the porous structure 310 may use the conductive film as in the coating material 230.

In the nanocarbon separation device 300 of the embodiment, while the case in which the first electrode 210 is the negative electrode and the second electrode 220 is the positive electrode has been exemplified, the nanocarbon separation device 300 of the embodiment is not limited thereto. In the nanocarbon separation device 300 of the embodiment, the first electrode 210 may be a positive electrode, and the second electrode 220 may be a negative electrode.

According to the nanocarbon separation device 300 of the embodiment, the porous structure 310 configured to hold the nanocarbon dispersion liquid is provided between the first electrode 210 and the second electrode 220. The nanocarbon separation method described below can be realized as follows in the process of separating the metal type nanocarbons and the semiconductor type nanocarbons contained in the nanocarbon dispersion liquid. That is, the separation can be immediately started using a method of constructing a carrier capable of containing and independently holding the nanocarbon dispersion liquid in the porous structure 310 by holding the nanocarbon dispersion liquid in the porous structure 310, and applying a voltage to a carrying surface thereof. In addition, even in collection after the separation, the collection can be rapidly performed without being affected by the disturbance of the solution. As a result, the disturbance or the like when an increase in capacity and improvement of an introduction speed are performed can be minimized, and efficient separation can be rapidly performed.

### Nanocarbon Separation Method

An action of the nanocarbon separation device 300 will be described while describing the nanocarbon separation method using the nanocarbon separation device 300 with reference to FIGS. 19 to 23. Further, in FIGS. 19 to 23, the same components as those of the nanocarbon separation device of the first embodiment shown in FIG. 1, the nanocarbon separation method of the first embodiment shown in FIGS. 2 to 6, the nanocarbon separation device of the third embodiment shown in FIG. 14, and the nanocarbon separation method of the third embodiment shown in FIGS. 15 to 18 are designated by the same reference numerals and overlapping description thereof will be omitted.

The nanocarbon separation method of the embodiment has a holding process, a contact process and a separation process. In the holding process, the nanocarbon dispersion liquid is held in the porous structure 310. In the contact process, the first electrode 210 comes into contact with at least a part of the upper end 310a of the porous structure 310, and the second electrode 220 comes into contact with at least a part of the lower end 310b of the porous structure 310. In the separation process, a direct current voltage is applied between the first electrode 210 and the second electrode 220, the metal type nanocarbons contained in the nanocarbon dispersion liquid are moved toward the first electrode 210 and the semiconductor type nanocarbons contained in the nanocarbon dispersion liquid are moved toward the second electrode 220, and thus, the metal type nanocarbons and the semiconductor type nanocarbons are separated.

In addition, the nanocarbon separation method of the embodiment may have a process of collecting the metal type nanocarbons and the semiconductor type nanocarbons contained in the nanocarbon dispersion liquid after the separation process (a collecting process).

First, as in the first embodiment, the single-walled carbon nanotube dispersion liquid is prepared.

Next, in the holding process, a process of holding the single-walled carbon nanotube dispersion liquid in the porous structure 310 is performed (ST1 in FIG. 7).

In the holding process, for example, as shown in FIG. 20, the single-walled carbon nanotube dispersion liquid is injected into the coating material 320 from a filler port 321 provided in the coating material 320 in advance, the single-walled carbon nanotube dispersion liquid infiltrates into the porous structure 310 in the coating material 320, and the single-walled carbon nanotube dispersion liquid is held in the porous structure 310. After holding of the single-walled carbon nanotube dispersion liquid in the porous structure 310 is terminated, the filler port 321 is sealed.

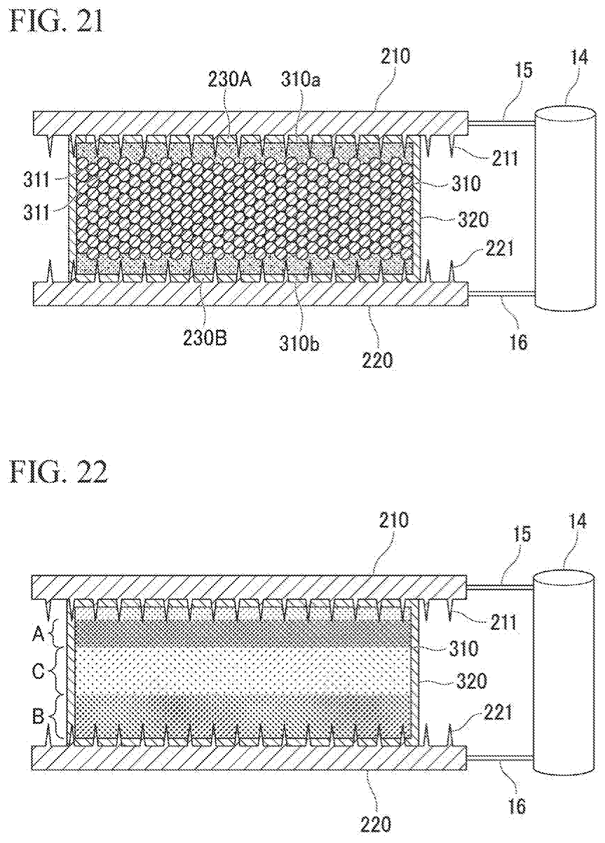

Next, in the contact process, as shown in FIG. 21, the protrusions 211 of the first electrode 210 reach the porous structure 310 through the region 230A of the coating material 320 that covers the upper end 310a of the porous structure 310. Accordingly, the first electrode 210 comes into contact with at least a part of the upper end 310a of the porous structure 310. Accordingly, the first electrode 210 is fixed to the upper end 310a of the porous structure 310. Similarly, the protrusions 221 of the second electrode 220 reach the porous structure 310 through the region 230B of the coating material 320 that covers the lower end 310b of the porous structure 310. Accordingly, the second electrode 220 comes into contact with at least a part of the lower end 310b of the porous structure 310 (ST2 in FIG. 7). Accordingly, the second electrode 220 is fixed to the lower end 310b of the porous structure 310.

Next, as in the first embodiment, in the separation process, as shown in FIG. 22, a process of moving the metal type single-walled carbon nanotubes contained in the single-walled carbon nanotube dispersion liquid toward the first electrode 210 and moving the semiconductor type single-walled carbon nanotubes contained in the single-walled carbon nanotube dispersion liquid toward the second electrode 220 through electrophoresis is performed. Accordingly, the metal type single-walled carbon nanotubes and the semiconductor type single-walled carbon nanotubes are separated (ST3 in FIG. 7).

When a direct current voltage is applied to the first electrode 210 and the second electrode 220, as in the first embodiment, as shown in FIG. 22, the single-walled carbon nanotube dispersion liquid is separated into three phases of the dispersion liquid phase A, the dispersion liquid phase B and the dispersion liquid phase C. The dispersion liquid phase A is a dispersion liquid phase having a relatively large content of the metal type single-walled carbon nanotubes. The dispersion liquid phase B is a dispersion liquid phase having a relatively large content of the semiconductor type single-walled carbon nanotubes. The dispersion liquid phase C is a dispersion liquid phase formed between the dispersion liquid phase A and the dispersion liquid phase B and having a relatively small content of the metal type single-walled carbon nanotubes and the semiconductor type single-walled carbon nanotubes.

After the separation process is terminated, in the collecting process, the metal type single-walled carbon nanotubes and the semiconductor type single-walled carbon nanotubes contained in the single-walled carbon nanotube dispersion liquid are collected. That is, the separated dispersion liquid phase A and the separated dispersion liquid phase B can each be collected (preparatively isolated) from the porous structure 310.

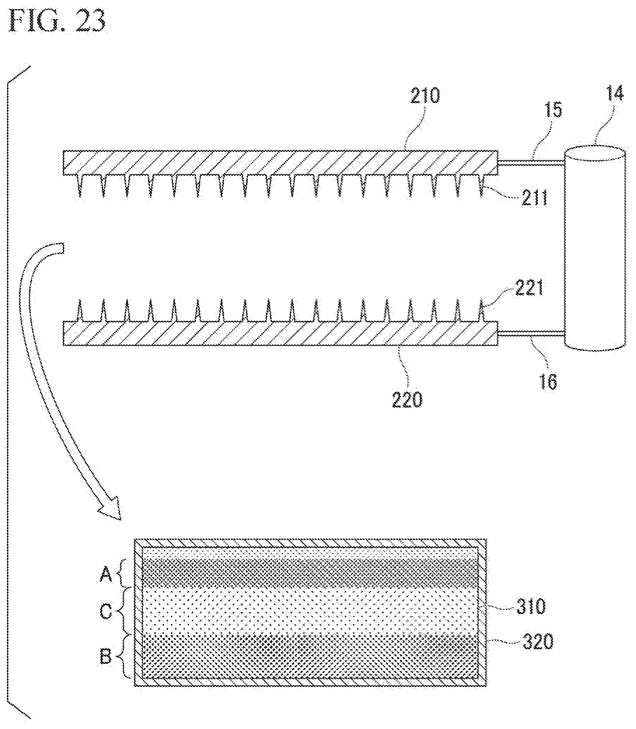

In the nanocarbon separation method of the embodiment, in collecting the dispersion liquid phase A and the dispersion liquid phase B, as shown in FIG. 23, the first electrode 210 and the second electrode 220 are separated from the porous structure 310 coated with the coating material 230.

Next, as in the first embodiment, the porous structure 310 is split into a portion corresponding to the dispersion liquid phase A, a portion corresponding to the dispersion liquid phase B, and a portion corresponding to the dispersion liquid phase C. In addition, simultaneously with the splitting, in the porous structure 310 split into three parts, a partition plate or the like is inserted between the portion corresponding to the dispersion liquid phase A and the portion corresponding to the dispersion liquid phase C, and a partition plate or the like is inserted between the portion corresponding to the dispersion liquid phase C and the portion corresponding to the dispersion liquid phase B. Then, the portion corresponding to the dispersion liquid phase A, the portion corresponding to the dispersion liquid phase B, and the portion corresponding to the dispersion liquid phase C are each collected.

In addition, as in the first embodiment, the collected dispersion liquid may be held in the porous structure 310 again, and an operation of separating the metal type single-walled carbon nanotubes and the semiconductor type single-walled carbon nanotubes contained in the single-walled carbon nanotube dispersion liquid through electrophoresis may be repeatedly performed.

Separation efficiency of the collected dispersion liquid can be estimated as in the first embodiment.

According to the nanocarbon separation method using the nanocarbon separation device 300 of the embodiment, the method can be realized as follows by holding the single-walled carbon nanotube dispersion liquid in the porous structure 310. That is, the separation by the single-walled carbon nanotube dispersion liquid can be immediately started using a method of constructing a carrier capable of containing and independently holding the single-walled carbon nanotube dispersion liquid in the porous structure 310, causing the electrodes to come into contact with a carrying surface thereof and applying a voltage thereto. In addition, even in collection after the separation, the collection can be rapidly performed without being affected by the disturbance of the solution.

In addition, according to the nanocarbon separation method using the nanocarbon separation device 300 of the embodiment, after the operation of separating the metal type single-walled carbon nanotubes and the semiconductor type single-walled carbon nanotubes is terminated, the separated metal type single-walled carbon nanotubes or the separated semiconductor type single-walled carbon nanotubes can be efficiently collected from the porous structure 310.

Further, in the nanocarbon separation method of the embodiment, the case in which the mixture of the single-walled carbon nanotubes is separated into the metal type single-walled carbon nanotubes and the semiconductor type single-walled carbon nanotubes has been exemplified. However, the nanocarbon separation method of the embodiment is not limited thereto. The nanocarbon separation method of the embodiment may be performed as a single-walled carbon nanotube purification method of separating the metal type single-walled carbon nanotubes and the semiconductor type single-walled carbon nanotubes in the porous structure 310, and then collecting only the single-walled carbon nanotubes having a targeted property.

### Fifth Embodiment

### Nanocarbon Separation Device

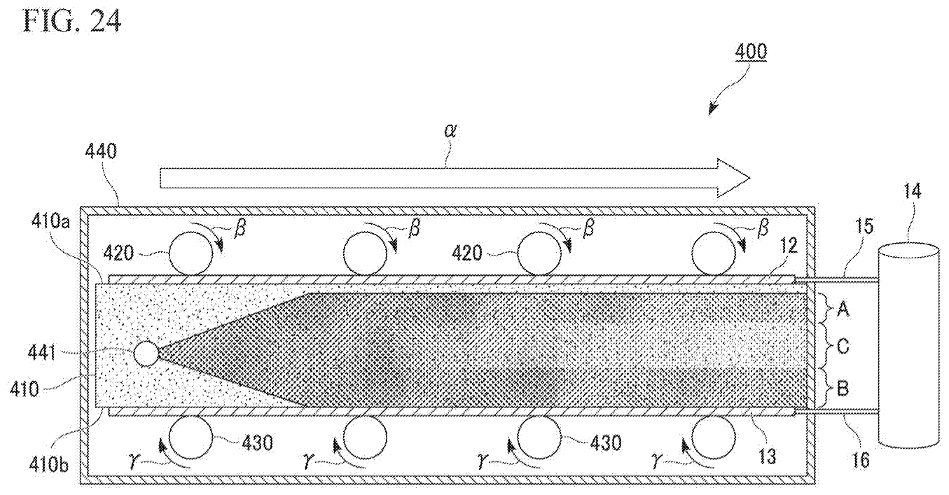

FIG. 24 is a schematic diagram showing a nanocarbon separation device of an embodiment. Further, in FIG. 24, the same components as those of the nanocarbon separation device of the first embodiment shown in FIG. 1 are designated by the same reference numerals and overlapping description thereof will be omitted.

A nanocarbon separation device 400 of the embodiment includes a porous structure 410, a first electrode 12 disposed to come into contact with an upper end 410a of the porous structure 410, a second electrode 13 disposed to come into contact with a lower end 410b of the porous structure 410, rollers 420 and 430 configured to convey the porous structure 410 in a longitudinal direction thereof, and a separation chamber 440 configured to accommodate the porous structure 410, the first electrode 12, the second electrode 13 and the rollers 420 and 430. In addition, the nanocarbon separation device 400 of the embodiment may include a direct current power supply 14. The direct current power supply 14 is electrically connected to the first electrode 12 via the cable 15, and electrically connected to the second electrode 13 via the cable 16.

The porous structure 410 has, for example, a quadrangular pole shape extending in a leftward/rightward direction in the drawing of FIG. 24.

For example, the porous structure 410 as the same structure as the porous structure 11.

The plurality of rollers 420 and 430 are provided at predetermined intervals in a direction in which the porous structure 410 is conveyed (a longitudinal direction of the porous structure 410, a direction shown by an arrow a in FIG. 24).

The porous structure 410 is conveyed in the longitudinal direction when the rollers 420 and 430 are rotated in a direction shown by arrows β and γ in FIG. 24.

The separation chamber 440 is not particularly limited as long as the porous structure 410, the first electrode 12, the second electrode 13 and the rollers 420 and 430 can be accommodated therein. A material of the separation chamber 440 is not particularly limited as long as the material is stable with respect to the nanocarbon dispersion liquid and is an insulating material.

A filler port 441 configured to inject the nanocarbon dispersion liquid into the porous structure 410 is provided in the separation chamber 440.

In the nanocarbon separation device 400 of the embodiment, while the case in which the first electrode 12 is the negative electrode and the second electrode 13 is the positive electrode has been exemplified, the nanocarbon separation device 400 of the embodiment is not limited thereto. In the nanocarbon separation device 400 of the embodiment, the first electrode 12 may be a positive electrode, and the second electrode 13 may be a negative electrode.

According to the nanocarbon separation device 400 of the embodiment, the porous structure 410 configured to hold the nanocarbon dispersion liquid is provided between the first electrode 12 and the second electrode 13. Accordingly, for example, the nanocarbon separation method, which will be described, can be realized as follows in the process of separating the metal type nanocarbons and the semiconductor type nanocarbons contained in the nanocarbon dispersion liquid. That is, the separation can be started simultaneously with introducing the solution with no disturbance by continuously introducing the solution into the porous structure 410 that can hold the dispersion liquid and continuously applying a voltage to the carrying surface. In addition, even in collection after the separation, collection of the porous structure can be rapidly performed.

### Nanocarbon Separation Method

An action of the nanocarbon separation device 400 will be described while describing the nanocarbon separation method using the nanocarbon separation device 400 with reference to FIG. 24.

The nanocarbon separation method of the embodiment has a contact process, a holding process and a separation process. The contact process is a process of causing the first electrode 12 to come into contact with at least a part of the upper end 410a of the porous structure 410 and causing the second electrode 13 to come into contact with at least a part of the lower end 410b of the porous structure 410. The holding process is a process of holding the nanocarbon dispersion liquid including nanocarbon in the porous structure 410. The separation process is a process of applying a direct current voltage between the first electrode 12 and the second electrode 13, moving the metal type nanocarbons contained in the nanocarbon dispersion liquid toward the first electrode 12 and moving the semiconductor type nanocarbons contained in the nanocarbon dispersion liquid toward the second electrode 13, and separating the metal type nanocarbons and the semiconductor type nanocarbons.

In addition, the nanocarbon separation method of the embodiment may have a process of collecting the metal type nanocarbons and the semiconductor type nanocarbons contained in the nanocarbon dispersion liquid after the separation process (a collecting process).

First, as in the first embodiment, the single-walled carbon nanotube dispersion liquid is prepared.

Next, in the contact process, as shown in FIG. 24, the first electrode 12 comes into contact with the upper end 410a of the porous structure 410, and the second electrode 13 comes into contact with the lower end 410b of the porous structure 410.

Here, in advance, the direct current power supply 14 is electrically connected to the first electrode 12 via the cable 15, and electrically connected to the second electrode 13 via the cable 16.

Next, as shown in FIG. 24, the roller 420 abuts the first electrode 12 in contact with the upper end 410a of the porous structure 410, and the roller 430 abuts the second electrode 13 in contact with the lower end 410b of the porous structure 410.

Next, in the holding process, a process of holding the single-walled carbon nanotube dispersion liquid in the porous structure 410 is performed.

In the holding process, for example, as shown in FIG. 24, the single-walled carbon nanotube dispersion liquid is injected into the separation chamber 440 from the filler port 441 provided in the separation chamber 440 in advance, the single-walled carbon nanotube dispersion liquid infiltrates into the porous structure 410 in the separation chamber 440, and the single-walled carbon nanotube dispersion liquid is held in the porous structure 410.

Next, as in the first embodiment, in the separation process, as shown in FIG. 24, a process of moving the metal type single-walled carbon nanotubes contained in the single-walled carbon nanotube dispersion liquid toward the first electrode 12 and moving the semiconductor type single-walled carbon nanotubes contained in the single-walled carbon nanotube dispersion liquid toward the second electrode 13 through electrophoresis is performed. Accordingly, the metal type single-walled carbon nanotubes and the semiconductor type single-walled carbon nanotubes are separated.

When a direct current voltage is applied to the first electrode 12 and the second electrode 13, as in the first embodiment, as shown in FIG. 24, the single-walled carbon nanotube dispersion liquid is separated into three phases of the dispersion liquid phase A, the dispersion liquid phase B and the dispersion liquid phase C. The dispersion liquid phase A is a dispersion liquid phase having a relatively large content of the metal type single-walled carbon nanotubes. The dispersion liquid phase B is a dispersion liquid phase having a relatively large content of the semiconductor type single-walled carbon nanotubes. The dispersion liquid phase C is a dispersion liquid phase formed between the dispersion liquid phase A and the dispersion liquid phase B and having a relatively small content of the metal type single-walled carbon nanotubes and the semiconductor type single-walled carbon nanotubes.

Further, in the nanocarbon separation method of the embodiment, the holding process and the separation process are performed while conveying the porous structure 410 in the longitudinal direction using the rollers 420 and 430. That is, the holding process and the separation process are continuously performed. More specifically, when the single-walled carbon nanotube dispersion liquid is injected into the separation chamber 440 from the filler port 441 while conveying the porous structure 410, the single-walled carbon nanotube dispersion liquid held in the porous structure 410 is gradually separated into three phases of the dispersion liquid phase A, the dispersion liquid phase B and the dispersion liquid phase C according to movement of the porous structure 410.

After the separation process is terminated, in the collecting process, the metal type single-walled carbon nanotubes and the semiconductor type single-walled carbon nanotubes contained in the single-walled carbon nanotube dispersion liquid are collected. That is, the separated dispersion liquid phase A and the separated dispersion liquid phase B are each collected (preparatively isolated) from the porous structure 410.

In the nanocarbon separation method of the embodiment, in order to collect the dispersion liquid phase A and the dispersion liquid phase B, the porous structure 410 is extracted from the separation chamber 440.

Next, as in the first embodiment, the porous structure 410 is split into the portion corresponding to the dispersion liquid phase A, the portion corresponding to the dispersion liquid phase B and the portion corresponding to the dispersion liquid phase C. In addition, simultaneously with the splitting, in the porous structure 410 split into three parts, a partition plate or the like is inserted between the portion corresponding to the dispersion liquid phase A and the portion corresponding to the dispersion liquid phase C, and a partition plate or the like is inserted between the portion corresponding to the dispersion liquid phase C and the portion corresponding to the dispersion liquid phase B. Then, the portion corresponding to the dispersion liquid phase A, the portion corresponding to the dispersion liquid phase B and the portion corresponding to the dispersion liquid phase C are each collected.

In addition, as in the first embodiment, the collected dispersion liquid may be held in the porous structure 410 again, and an operation of separating the metal type single-walled carbon nanotubes and the semiconductor type single-walled carbon nanotubes contained in the single-walled carbon nanotube dispersion liquid through electrophoresis may be repeatedly performed.

Separation efficiency of the collected dispersion liquid can be estimated as in the first embodiment.

According to the nanocarbon separation method using the nanocarbon separation device 400 of the embodiment, the solution is continuously introduced into the porous structure 410 configured to hold the single-walled carbon nanotube dispersion liquid, and a voltage is continuously applied to the carrying surface. Accordingly, the separation can be started simultaneously with introduction of the solution with no disturbance. In addition, even in collection after the separation, collection of the porous structure can be rapidly performed.

According to the nanocarbon separation method using the nanocarbon separation device 400 of the embodiment, after an operation of separating the metal type single-walled carbon nanotubes and the semiconductor type single-walled carbon nanotubes is terminated, the separated metal type single-walled carbon nanotubes or the separated semiconductor type single-walled carbon nanotubes can be efficiently collected from the porous structure 410.

The nanocarbon separation method of the embodiment may be performed as a single-walled carbon nanotube purification method of separating the metal type single-walled carbon nanotubes and the semiconductor type single-walled carbon nanotubes in the porous structure 410, and then collecting only the single-walled carbon nanotube having a targeted property.

Hereinabove, while the embodiment that can be applied to the case in which the mixture of the single-walled carbon nanotubes is separated into the metal type single-walled carbon nanotubes and the semiconductor type single-walled carbon nanotubes has been described, the present invention can also be applied to a case in which a mixture of multi-walled carbon nanotubes, a mixture of double-walled carbon nanotube, a mixture of grapheme, and the like are separated.

Priority is claimed on Japanese Patent Application No. 2017-197276, filed Oct. 10, 2017, the content of which is incorporated herein by reference.

### REFERENCE SIGNS LIST

10, 100, 200, 300, 400 Nanocarbon separation device

11, 310, 410 Porous structure

12, 210 First electrode

13, 220 Second electrode

14 Direct current power supply

15, 16 Cable

17 Weight

20 Substrate

30 Nanocarbon dispersion liquid

40 Dispersion liquid tank

50 Cutting blade

110 Housing

211, 221 Protrusion

230, 320 Coating material

231, 321, 441 Filler port

311 Particles

420, 430 Roller

440 Separation chamber

1. A nanocarbon separation device, comprising:
a porous structure configured to hold a dispersion liquid containing nanocarbons;
a first electrode disposed to come into contact with at least a part of an upper end of the porous structure; and
a second electrode disposed to come into contact with at least a part of a lower end of the porous structure.

2. The nanocarbon separation device according to claim 1, wherein the porous structure is constituted by sponge.

3. The nanocarbon separation device according to claim 1, wherein the porous structure is constituted by a plurality of particles.

4. The nanocarbon separation device according to claim 1, wherein the porous structure is disposed between the first electrode and the second electrode to be attachable and detachable.

5. The nanocarbon separation device according to claim 1, wherein the porous structure is coated with a coating material.

6. The nanocarbon separation device according to claim 5, wherein a plurality of protrusions are provided on each of the first electrode and the second electrode.

7. The nanocarbon separation device according to claim 6, wherein the plurality of protrusions come into contact with the porous structure through the coating material.

8. A nanocarbon separation method, comprising:
holding a dispersion liquid containing nanocarbons in a porous structure;
causing a first electrode to come into contact with at least a part of an upper end of the porous structure and causing a second electrode to come into contact with at least a part of a lower end of the porous structure; and
applying a direct current voltage between the first electrode and the second electrode, moving metal type nanocarbons contained in the dispersion liquid toward the first electrode and moving semiconductor type nanocarbons contained in the dispersion liquid toward the second electrode, and separating the metal type nanocarbons and the semiconductor type nanocarbons.

9. The nanocarbon separation method according to claim 8, comprising collecting the metal type nanocarbons and the semiconductor type nanocarbons contained in the dispersion liquid after the separation process.

10. The nanocarbon separation method according to claim 8, wherein the process of holding and the process of separation are continuously performed.
